(19) United States
(12) Patent Application Publication
(10) Pub. No.: US 2024/0077743 A1
(43) Pub. Date: Mar. 7, 2024

(54) IMAGING-LENS MANUFACTURING APPARATUS AND CAMERA-MODULE MANUFACTURING APPARATUS

(71) Applicant: Sharp Sensing Technology Corporation, Tenri City (JP)

(72) Inventor: Akihiro IIDA, Tenri City (JP)

(21) Appl. No.: 18/139,904

(22) Filed: Apr. 26, 2023

(30) Foreign Application Priority Data
Jun. 28, 2022 (JP) 2022-103920

(51) Int. Cl. G02B 27/62; G03B 43/00

(52) U.S. Cl. CPC G02B 27/62; G03B 43/00

(57) ABSTRACT

An imaging-lens manufacturing apparatus manufactures an imaging lens provided with a plurality of lenses including an adjusted lens. The imaging-lens manufacturing apparatus includes a stage configured to hold at least the plurality of lenses excluding the adjusted lens; a lens adjusting mechanism configured to hold the adjusted lens, and capable of adjusting a position of the adjusted lens with respect to the plurality of lenses excluding the adjusted lens; a light source; a reticle disposed between the imaging lens and the light source, and having three or more slits that allow light from the light source to pass; and a light detecting unit having a plurality of sensors each configured to detect, via the imaging lens, a corresponding one of a plurality of light-ray bundles composed of the light from the light source passed through the three or more slits.

### CROSS-REFERENCE TO RELATED APPLICATION

The present application claims priority from Japanese Application JP2022-103920, the content of which is hereby incorporated by reference into this application.

### BACKGROUND OF THE INVENTION

### 1. Field of the Invention

The present invention relates to an imaging-lens manufacturing apparatus and a camera-module manufacturing apparatus that adjust a lens on the basis of information about an image taken by an image pickup element.

### 2. Description of the Related Art

Recent rapid advancement toward high resolution and high performance in camera modules makes it difficult to improve component accuracy in conformance with the advancement to high resolution. Highly accurate assembly is required because the accuracy of assembly of a plurality of lenses that constitute an imaging lens in a process of manufacturing the imaging lens considerably affects the ratio of non-defective products in the process of manufacturing the imaging lens.

By the way, a known method in the process of manufacturing an imaging lens is adjusting the optical performance of the imaging lens by adjusting the position of an adjusted lens among a plurality of lenses disposed in the lens barrel's body. For instance, Japanese Unexamined Patent Application Publication No. 2010-230745 proposes a method of adjusting a tilt of an image plane by moving an adjusted lens horizontally on the basis of information about an image taken by an image pickup element, in such a manner that the absolute value of a tilt of a tangential image plane with respect to the optical axis and the absolute value of a tilt of a sagittal image plane with respect to the optical axis are substantially equal.

### SUMMARY OF THE INVENTION

However, Japanese Unexamined Patent Application Publication No. 2010-230745 is silent about how to adjust the adjusted lens. Furthermore, the tangential image plane and the sagittal image plane have their tilts remaining after adjustment in the invention described in Japanese Unexamined Patent Application Publication No. 2010-230745. Japanese Unexamined Patent Application Publication No. 2010-230745 thus requires the imaging lens or an image sensor of a camera module to undergo tilt adjustment in order to use the imaging lens after adjustment effectively.

In view of the above problem, one aspect of the present invention aims to provide an imaging-lens manufacturing apparatus and a camera-module manufacturing apparatus that can manufacture a higher-accuracy imaging lens while preventing a tilt of each of the tangential image plane and sagittal image plane.

To solve the above problem, an imaging-lens manufacturing apparatus according to one aspect of the present invention manufactures an imaging lens provided with a plurality of lenses including an adjusted lens that is used in assembly. The imaging-lens manufacturing apparatus includes the following: a stage configured to hold at least the plurality of lenses excluding the adjusted lens; a lens adjusting mechanism configured to hold the adjusted lens, and capable of adjusting, in a plane perpendicular to the optical axis of the imaging lens, the position of the adjusted lens with respect to the plurality of lenses excluding the adjusted lens; a light source; a reticle disposed between the imaging lens and the light source, and having three or more slits that allow light from the light source to pass; and a light detecting unit having a plurality of sensors each configured to detect, via the imaging lens, a corresponding one of a plurality of light-ray bundles composed of the light from the light source passed through the three or more slits, wherein the lens adjusting mechanism is further capable of adjusting a tilt angle of the adjusted lens with respect to the optical axis, and the tilt angle undergoes adjustment by rotating the adjusted lens about a rotation center point located on the optical axis.

An imaging-lens manufacturing apparatus according to another aspect of the present invention manufactures an imaging lens provided with a plurality of lenses including an adjusted lens that is used in assembly. The imaging-lens manufacturing apparatus includes the following: a stage configured to hold at least the plurality of lenses excluding the adjusted lens; a lens adjusting mechanism configured to hold the adjusted lens, and capable of adjusting, in a plane perpendicular to an optical axis of the imaging lens, the position of the adjusted lens with respect to the plurality of lenses excluding the adjusted lens; a chart with a pattern formed so that the optical performance in the tangential direction and sagittal direction of the imaging lens is evaluable; and an image pickup element configured to take an image of the chart through the imaging lens, wherein the lens adjusting mechanism is further capable of adjusting a tilt angle of the adjusted lens with respect to the optical axis, and the tilt angle undergoes adjustment by rotating the adjusted lens about a rotation center point located on the optical axis.

A camera-module manufacturing apparatus according to one aspect of the present invention manufactures a camera module having an imaging lens and an image pickup element. The imaging lens is provided with a plurality of lenses including an adjusted lens that is used in assembly. The camera-module manufacturing apparatus includes the following: a stage configured to hold the camera module; a lens adjusting mechanism configured to hold the adjusted lens, and capable of adjusting, in a plane perpendicular to the optical axis of the imaging lens, the position of the adjusted lens with respect to the plurality of lenses excluding the adjusted lens; and a chart with a pattern formed so that the optical performance in the tangential direction and sagittal direction of the imaging lens is evaluable, wherein the lens adjusting mechanism is further capable of adjusting a tilt angle of the adjusted lens with respect to the optical axis, and the tilt angle undergoes adjustment by rotating the adjusted lens about a rotation center point located on the optical axis of the imaging lens.

These aspects of the present invention can provide an imaging-lens manufacturing apparatus and a camera-module manufacturing apparatus that can manufacture a higher-accuracy imaging lens with a reduced tilt of each of the tangential image plane and sagittal image plane.

### BRIEF DESCRIPTION OF THE DRAWINGS

FIG. 1 is a schematic diagram of an example configuration of an imaging-lens manufacturing apparatus according to a first preferred embodiment of the present invention;

FIG. 2 illustrates, by way of example, how a lens adjusting mechanism of the imaging-lens manufacturing apparatus adjusts an adjusted lens;

FIG. 3 is a top view of an example reticle of the imaging-lens manufacturing apparatus;

FIG. 4 is a schematic diagram of example pathways of light-ray bundles in the imaging-lens manufacturing apparatus;

FIG. 5 illustrates an example distance D in the direction of the optical axis from the principle point of the adjusted lens to a rotation center point;

FIG. 6 schematically illustrates the relationship between PS and a focal-point position;

FIG. 7 is a schematic diagram showing, in each light-ray bundle, the relationship between a position in the direction of the optical axis and optical performance;

FIG. 8 is a flowchart showing, by way of example, how the imaging-lens manufacturing apparatus manufactures an imaging lens;

FIG. 9 is a schematic diagram of an example configuration of an imaging-lens manufacturing apparatus according to a second preferred embodiment of the present invention;

FIG. 10 is a top view of an example chart of the imaging-lens manufacturing apparatus; and

FIG. 11 is a schematic diagram of an example configuration of a camera-module manufacturing apparatus according to a third preferred embodiment of the present invention.

### DETAILED DESCRIPTION OF THE INVENTION

### First Preferred Embodiment

Preferred embodiments of the present invention will be detailed. The following describes, by way of example, an imaging-lens manufacturing apparatus according to the present invention, and the technical scope of the present invention is thus not limited to the illustrated examples. It is noted that some of the drawings describe, as appropriate, a coordinate system with its X- Y- and Z-axes orthogonal to each other. In the coordinate system, the direction of an optical axis L of an imaging lens 110 placed in an imaging-lens manufacturing apparatus 100 will be referred to as a Z-axis direction. Further, the width direction of the imaging-lens manufacturing apparatus 100 orthogonal to the Z-axis direction will be referred to as an X-axis direction, and the depth direction of the imaging-lens manufacturing apparatus 100 orthogonal to the X-axis direction and the Z-axis direction will be referred to as a Y-axis direction.

### Imaging-Lens Manufacturing Apparatus 100

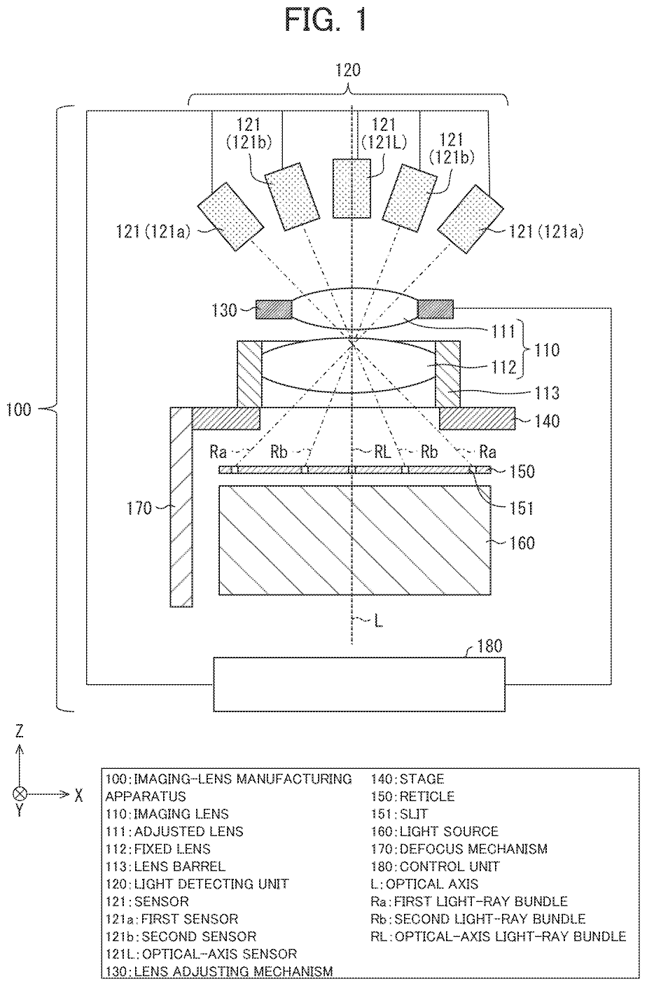

FIG. 1 is a schematic diagram of an example configuration of the imaging-lens manufacturing apparatus 100 according to the first preferred embodiment of the present invention. The imaging-lens manufacturing apparatus 100 is an apparatus that manufactures the imaging lens 110 provided with a plurality of lenses including an adjusted lens 111 that is used in assembly.

The imaging lens 110 is composed of the adjusted lens 111, a fixed lens 112, and a lens barrel 113. The lens barrel 113 holds the fixed lens 112 and is fixed to a stage 140. A plurality of adjusted lenses 111 and a plurality of fixed lenses 112 may be provided.

The imaging-lens manufacturing apparatus 100 includes a light detecting unit 120, a lens adjusting mechanism 130, the stage 140, a reticle 150, a light source 160, a defocus mechanism 170, and a control unit 180.

The stage 140 is configured to, for instance, hold the lens barrel 113, thus holding at least lenses (fixed lens 112) excluding the adjusted lens 111. The stage 140 is held by the defocus mechanism 170 that drives in the direction of the optical axis L of the imaging lens 110.

The defocus mechanism 170 performs defocus in which the distance of the reticle 150 with respect to the lenses (fixed lens 112) excluding the adjusted lens 111 held by the stage 140 undergoes change in the direction of the optical axis L. The defocus mechanism 170 moves the stage 140 in the direction of the optical axis L to perform defocus. The light source 160 emits light toward the imaging lens 110.

### Lens Adjusting Mechanism 130

The lens adjusting mechanism 130 holds the adjusted lens 111 and can adjust, in a plane perpendicular to the optical axis L of the imaging lens 110 (a plane passing through the X-axis and the Y-axis), the position of the adjusted lens 111 with respect to the fixed lens 112.

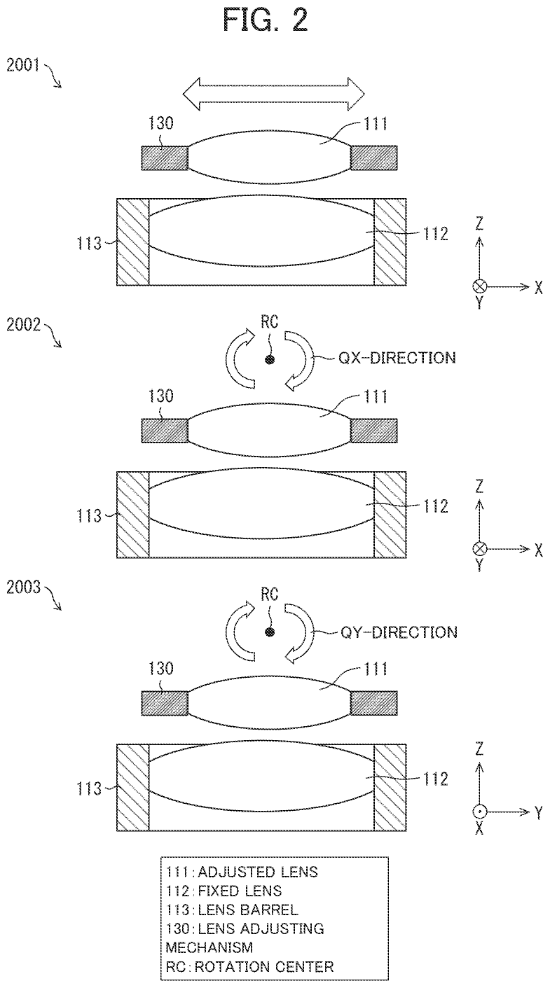

FIG. 2 illustrates, by way of example, how the lens adjusting mechanism 130 of the imaging-lens manufacturing apparatus 100 adjusts the adjusted lens 111. The adjusted lens 111 undergoes positional adjustment in the plane perpendicular to the optical axis L, as illustrated in 2001 in FIG. 2 (open arrow in 2001 in FIG. 2).

The lens adjusting mechanism 130 includes a biaxial fine-movement stage that can adjust the adjusted lens 111 in the plane perpendicular to the optical axis L while holding the adjusted lens 111. The lens adjusting mechanism 130 with this configuration moves the adjusted lens 111 in the plane perpendicular to the optical axis L to adjust the imaging lens 110.

Further, the lens adjusting mechanism 130 can adjust the tilt angle of the adjusted lens 111 with respect to the optical axis L; as illustrated in 2002 and 2003 in FIG. 2, the tilt angle undergoes adjustment by rotating the adjusted lens 111 about a rotation center point RC, which is located on the optical axis L. This can prevent a tilt of a tangential image plane and a tilt of a sagittal image plane and can adjust the adjusted lens 111 without tilting the optical axis L.

In other words, the lens adjusting mechanism 130 includes a quadaxial fine-movement stage on which the lens adjusting mechanism 130 can adjust the adjusted lens 111 in X-, Y-, θX- and θY-directions perpendicular to the optical axis L while holding the adjusted lens 111. Rotation in the θX- and θY-directions is adjusted using the rotation center RC for tilt adjustment as the center. With the foregoing configuration, the adjusted lens 111 is moved in the X-, Y-, θX- and θY-directions, thus adjusting the imaging lens 110.

The lens adjusting mechanism 130 also includes a fine-movement stage that can drive in the direction of the optical axis L and can drive the adjusted lens 111 in the direction of the optical axis L. This can not only adjust the distance between the adjusted lens 111 and the fixed lens 112 suitably, but also separate the adjusted lens 111 from the fixed lens 112 when the adjusted lens 111 undergoes adjustment in the plane perpendicular to the optical axis L. As a result, a frictional resistance between the adjusted lens 111 and the fixed lens 112 during the adjustment of the imaging lens 110 can be reduced.

The adjusted lens 111 undergoes the foregoing positional adjustment, followed by movement in the direction of the optical axis L to a location where the adjusted lens 111 comes into contact with the fixed lens 112, and the adjusted lens 111 is finally fixed to the fixed lens 112.

### Reticle 150

The reticle 150 is disposed between the imaging lens 110 and the light source 160 and has three or more slits 151 that allow light from the light source 160 to pass. The light from the light source 160 passes through the slits 151, thus obtaining a plurality of light-ray bundles.

As illustrated in FIG. 1, the plurality of light-ray bundles include the following: an optical-axis light-ray bundle RL that coincides with the optical axis L; and a pair of first light-ray bundles Ra, a pair of second light-ray bundles Rb, a pair of third light-ray bundles (not shown), and a pair of fourth light-ray bundles (not shown), each of which is a pair of light-ray bundles that is emitted in a direction symmetric with respect to the optical axis L.

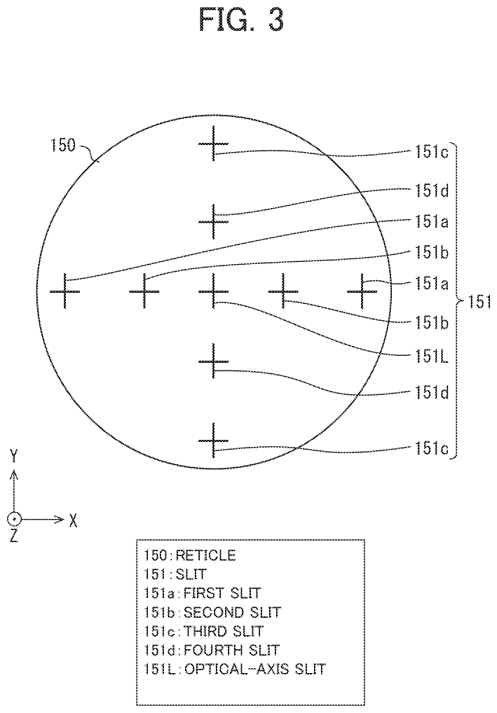

FIG. 3 is a top view of an example of the reticle 150 of the imaging-lens manufacturing apparatus 100. As illustrated in FIG. 3, the slits 151 include an optical-axis slit 151L, a pair of first slits 151a, a pair of second slits 151b, a pair of third slits 151c, and a pair of fourth slits 151d.

The light from the light source 160 passes through the optical-axis slit 151L, the pair of first slits 151a, the pair of second slits 151b, the pair of third slits 151c and the pair of fourth slits 151d, thus respectively obtaining the optical-axis light-ray bundle RL, the pair of first light-ray bundles Ra, the pair of second light-ray bundles Rb, the pair of third light-ray bundles and the pair of fourth light-ray bundles.

Each slit 151 is disposed in the reticle 150 in the following manner. The optical-axis slit 151L is disposed in such a manner that a light-ray bundle that passes through the optical-axis slit 151L constitutes the optical-axis light-ray bundle RL along the optical axis L. That is, the optical-axis slit 151L is disposed on the optical axis L.

The pair of first slits 151a is disposed in such a manner that each of the pair of first light-ray bundles Ra corresponds to an image height of 60% or greater (first adjustment image height) of the maximum image height. That is, the pair of first slits 151a is disposed in such a manner that each of the first light-ray bundles Ra concentrates, in an image plane, on a location having an image height of 60% or greater of the maximum image height. In other words furthermore, each of the first slits 151a is disposed in such a manner that an image is formed, in an image plane, in a location having an image height of 60% or greater of the maximum image height.

The pair of second slits 151b is disposed in such a manner that each of the pair of second light-ray bundles Rb corresponds to an image height of 10% or greater and 50% or smaller (second adjustment image height) of the maximum image height. That is, the pair of second slits 151b is disposed in such a manner that each of the second light-ray bundles Rb concentrates, in the image plane, on a location having an image height of 10% or greater and 50% or smaller of the maximum image height. In other words furthermore, each of the second slits 151b is disposed in such a manner that an image is formed, in the image plane, in a location having an image height of 10% or greater and 50% or smaller of the maximum image height.

The pair of third slits 151c is disposed in such a manner that each of the third light-ray bundles is emitted, from the first light-ray bundles Ra, in a direction rotated about the optical axis L. The pair of fourth slits 151d is disposed in such a manner that each of the fourth light-ray bundles is emitted, from the second light-ray bundles Rb, in the direction rotated about the optical axis L.

Here, the image heights are each a distance from the optical axis L in the plane perpendicular to the optical axis L; the image heights on concentric circles with the optical axis L serving as their center are equal on the plane perpendicular to the optical axis L. Further, the maximum image height may coincide with the radius of an image circle in the plane perpendicular to the optical axis L. The radius of the image circle indicates a maximum radius at which an image can be formed.

Further, an image height that is used for adjusting the imaging lens 110 is defined as an adjustment image height. For an adjustment image height set at, for instance, 50% of a maximum image height, there are two locations having an adjustment image height of 50% of the maximum image height on a single axis passing through the optical axis L in the plane perpendicular to the optical axis L.

As illustrated in FIG. 3, the pair of first slits 151a is symmetric with respect to the optical-axis slit 151L for instance. Further, the pair of third slits 151c is symmetric with respect to the optical-axis slit 151L. The first slits 151a and the third slits 151c are disposed alternately at 90-degree pitches on an identical circle having the optical-axis slit 151L as its center.

The pair of second slits 151b is symmetric with respect to the optical-axis slit 151L. Further, the pair of fourth slits 151d is symmetric with respect to the optical-axis slit 151L. The second slits 151b and the fourth slits 151d are disposed alternately at 90-degree pitches on an identical circle having the optical-axis slit 151L as its center.

The second slits 151b are disposed on a straight line passing through the optical-axis slit 151L and the first slits 151a, and the fourth slits 151d are disposed on a straight line passing through the optical-axis slit 151L and the third slits 151c.

It is noted that the positions of the slits 151 in the reticle 150 are not limited to the foregoing; the slits 151 each need to be disposed in the reticle 150 so as to be able to generate a light-ray bundle that corresponds to an image height (adjustment image height) that is used for adjusting the imaging lens 110. The imaging lens 110 undergoes adjustment on the basis of one or more adjustment image heights. The slits 151 may thus have only the optical-axis slit 151L and the first slits 151a for instance.

Further, the imaging lens 110 desirably undergoes adjustment on the basis of two or more adjustment image heights. The slits 151 in this case may have, for instance, only the optical-axis slit 151L, the first slits 151a and the second slits 151b or may have, for instance, the optical-axis slit 151L, the first slits 151a and the fourth slits 151d. The reason why the imaging lens 110 desirably undergoes adjustment on the basis of two or more adjustment image heights will be detailed later on.

The reticle 150 is placed in a location coinciding approximately with the focal plane of the imaging lens 110 and is composed of a metal thin plate. Further, the slits 151 are desirably in the form of a cross along each direction in order to measure optical performance in a tangential direction and a sagittal direction at a predetermined image height.

The light emitted from the light source 160 passes through the slits 151, then enters and passes through the imaging lens 110 and is then detected by sensors 121, which constitutes the light detecting unit 120.

### Light Detecting Unit 120

The light detecting unit 120 has a plurality of sensors 121 each of which detects, via the imaging lens 110, a corresponding one of a plurality of light-ray bundles composed of the light from the light source 160 passed through the slits 151.

As illustrated in FIG. 1, the light detecting unit 120 has four or more sensors 121. The sensor 121 specifically includes an optical-axis sensor 121L, first sensors 121a, second sensors 121b, third sensors (not shown), and fourth sensors (not shown).

The optical-axis sensor 121L detects the optical-axis light-ray bundle RL. In other words, the optical-axis sensor 121L detects light at the center of the image circle. The optical-axis sensor 121L is disposed in a location coinciding substantially with the optical axis L.

The first sensors 121a through the fourth sensors detect light at peripheral image heights in the image circle. The peripheral image heights are image heights in locations separated from the optical axis L by a predetermined distance.

The first sensors 121a detect the pair of respective first light-ray bundles Ra. The first sensors 121a in a pair are disposed symmetrically with respect to the optical axis L. The second sensors 121b detect the pair of respective second light-ray bundles Rb. The second sensors 121b in a pair are disposed symmetrically with respect to the optical axis L.

The third sensors detect the pair of respective third light-ray bundles. The third sensors are disposed symmetrically with respect to the optical axis L and are disposed in locations rotated about the optical axis L from the first sensors 121a. The fourth sensors detect the pair of respective fourth light-ray bundles. The fourth sensors are disposed symmetrically with respect to the optical axis L and are disposed in locations rotated about the optical axis L from the second sensors 121b.

It is noted that FIG. 1 illustrates a non-limiting instance where the sensors 121 are disposed so as to form a fan shape protruding in a direction where the light from the light source 160 is emitted. Nevertheless, arranging the sensors 121 in the form of a fan can prevent the size of the imaging-lens manufacturing apparatus 100.

Further, for fan-shaped placement of the sensors 121, placing the sensors 121 inside the dome-shaped portion of a dome-shaped support (not shown) enables the sensors 121 to be arranged in the form of a fan. For such fan-shaped placement of the sensors 121 using a dome-shaped support, placing the sensors 121 in this support, which allows a placement angle for the sensors 121 to be determined roughly, facilitates the adjustment of the placement angle of the sensors 121.

The first sensors 121a, which detect the first light-ray bundles Ra, and the third sensors, which detect the third light-ray bundles, are disposed alternately at 90-degree pitches on an identical circle having the optical axis L as its center. Furthermore, the second sensors 121b, which detect the second light-ray bundles Rb, and the fourth sensors, which detect the fourth light-ray bundles, are disposed alternately at 90-degree pitches on an identical circle having the optical axis L as its center. That is, the light detecting unit 120 in this preferred embodiment includes nine sensors 121.

FIG. 1 illustrates the light detecting unit 120 configured such that the optical-axis sensor 121L is disposed in a location where the optical-axis light-ray bundle RL is detected, and that four sensors 121 are disposed in locations where light that corresponds to adjustment image heights is detected. The light detecting unit 120 further includes other four sensors 121 in an axial direction not shown.

It is noted that when the imaging lens 110 undergoes adjustment on the basis of a single adjustment image height, the optical-axis sensor 121L for instance is disposed, and the first sensors 121a and the third sensors for instance are alternately disposed at 90-degree pitches on an identical circle having the optical axis L as its center. In this case, five sensors 121 in total are disposed.

Further, the sensors 121 do not necessarily have to be disposed at 90-degree pitches around the optical axis L. When three or more sensors 121 are disposed for a single adjustment image height, and when the sensors 121 are disposed around the optical axis L at a known angle, the amount of adjustment in the X-axis direction and Y-axis direction of the adjusted lens 111 can be determined by converting an image plane tilt into an X-axial component and a Y-axial component.

When the imaging lens 110 undergoes adjustment on the basis of a single adjustment image height for instance, the light detecting unit 120 may include the optical-axis sensor 121L and the first sensors 121a disposed in the following manner. For instance, the first sensors 121a may be disposed at 120-degree pitches around the optical axis L on concentric circles having their centers coinciding with the optical axis L and having their radiuses coinciding with the first adjustment image height. The light detecting unit 120 in this case includes four sensors 121 in total.

Further, when the imaging lens 110 undergoes adjustment on the basis of two adjustment image heights, the light detecting unit 120 may include the second sensors 121b disposed in the following manner, in addition to the sensors 121 in the case where the imaging lens 110 undergoes adjustment on the basis of a single adjustment image height. For instance, the second sensors 121b may be disposed at 120-degree pitches around the optical axis L on concentric circles having their centers coinciding with the optical axis L and having their radiuses coinciding with the second adjustment image height. The light detecting unit 120 in this case includes seven sensors 121 in total.

Furthermore, when the imaging lens 110 undergoes adjustment on the basis of three adjustment image heights, the light detecting unit 120 may include fifth sensors disposed in the following manner and configured to detect fifth light-ray bundles corresponding to a third adjustment image height, in addition to the sensors 121 in the case where the imaging lens 110 undergoes adjustment on the basis of two adjustment image heights. For instance, the fifth sensors may be disposed at 120-degree pitches around the optical axis L on concentric circles having their centers coinciding with the optical axis L and having their radiuses coinciding with the third adjustment image height. The light detecting unit 120 in this case includes ten sensors 121 in total.

It is noted that the slits 151, disposed in the reticle 150, are disposed in correspondence with the respective sensors 121.

### Control Unit 180

The control unit 180 controls the individual units of the imaging-lens manufacturing apparatus 100 and derives optical performance from an image formed by each of the light-ray bundles detected by a corresponding one of the sensors 121. To be specific, the control unit 180 derives, as the optical performance, a modulation transfer function (MTF) from an image formed by a light-ray bundle detected by each sensor 121.

The control unit 180 controls the defocus mechanism 170 to calculate, while performing defocus, a tilt of the tangential image plane and a tilt of the sagittal plane in accordance with the MTF derived about the pair of first light-ray bundles Ra.

The control unit 180 is capable of MTF evaluation in correspondence with defocus by subjecting the imaging lens 110 to defocus and can obtain focal-point information at an adjustment image height of the imaging lens 110. The focal-point information includes information about the focal-point position of each light-ray bundle for instance. The control unit 180 can further determine differences in focal length in the tangential image plane and sagittal image plane on the basis of the focal-point information.

The control unit 180 controls the lens adjusting mechanism 130 on the basis of the calculated tilts of the tangential image plane and sagittal image plane.

To be specific, the control unit 180 calculates the following from the tilts of the tangential image plane and sagittal image planes: (1) the amount of positional adjustment of the adjusted lens 111 in the plane perpendicular to the optical axis L with respect to the fixed lens 112; and (2) the amount of rotational adjustment of the tilt angle of the adjusted lens 111. The control unit 180 also controls the lens adjusting mechanism 130 to adjust the following on the basis of these calculated amounts of adjustment of the adjusted lens 111: (1) the position of the adjusted lens 111 with respect to the fixed lens 112 in the plane perpendicular to the optical axis L; and (2) the tilt angle of the adjusted lens 111.

The control unit 180 furthermore controls the lens adjusting mechanism 130 to drive the adjusted lens 111 in the direction of the optical axis L in such a manner that the adjusted lens 111 comes into contact with the lenses (fixed lens 112) excluding the adjusted lens 111.

### Calculation of Image Plane Tilt

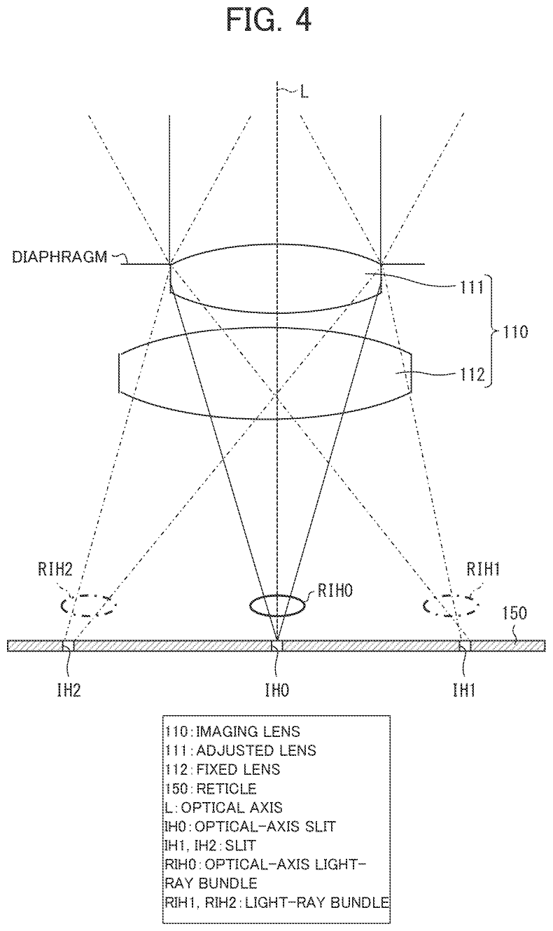

The following describes an example of how the control unit 180 calculates an image plane tilt with reference to FIG. 4. FIG. 4 is a schematic diagram of example pathways in the imaging-lens manufacturing apparatus 100. FIG. 4 illustrates that the imaging lens 110 with its image plane tilted. To be specific, when the imaging lens 110 in FIG. 4 is in focus on the focal-point position of an optical-axis light-ray bundle RIH0 passing through an optical-axis slit IH0, a light-ray bundle RIH1 passed through a slit IH1 is brought into focus in front of an ideal image plane, and a light-ray bundle RIH2 passed through a slit IH2 is brought into focus behind the ideal image plane. Here, the ideal image plane is a plane perpendicular to the optical axis L and passing through the optical-axis light-ray bundle RIH0. The slit IH1 and the slit IH2 are disposed in locations symmetric with respect to the optical axis L, and the focal-point positions of the light-ray bundle RIH1 and light-ray bundle RIH2 are on the ideal image plane and in locations symmetric with respect to the optical axis L on the ideal image plane when the image plane has no tilt.

The imaging lens 110 is typically required to form an image without tilt at all image heights onto an ideal image plane, which is flat typically. That is, it is ideal that the focal-point position of the optical-axis light-ray bundle RIH0, passing through the optical-axis slit IH0, and the focal-point positions of the light-ray bundle RIH1 and light-ray bundle RIH2 are identical. However, variations in manufacturing lenses, or a coaxial misalignment or tilt in assembly cause the image plane to tilt with respect to the ideal image plane, as illustrated in FIG. 4, during a process step for manufacturing the imaging lens 110.

Here, the tilt of the image plane is defined as the following peak separation (PS), which is expressed by Expression (1) below.

PS=FP1−FP2 Expression (1)

FP1 is the focal-point position in the tangential image plane (T-plane) or sagittal image plane (S-plane) of the light-ray bundle RIH1 of the imaging lens 110. FP2 is a focal-point position in the T-plane or S-plane at an image height having the same distance to the optical axis L as FP1 and being in the minus direction. That is, FP2 is a focal-point position in the T-plane or S-plane of the light-ray bundle RIH2. As described above, the tilt PS can be determined by a difference in focal-point position in the direction of the optical axis L between the positions of a pair of sensors 121 in the T-plane or S-plane.

For no image plane tilt, PS stands at zero, and for an image plane tilt, PS corresponding to the tilt angle and the position of a peripheral image height occurs.

### Calculation of Amount of Adjustment of Adjusted Lens 111

The following describes how the control unit 180 determines each amount of adjustment of the adjusted lens 111.

In the positional adjustment of the adjusted lens 111 in the plane perpendicular to the optical axis L, PS is substantially in linear relation to the amount of movement in the plane perpendicular to the optical axis L and can be expressed by Expression (2) and Expression (3) below. However, these expressions do not apply when the adjusted lens 111 has a smaller refractive index than the other lenses constituting the imaging lens 110, or when PS is so large that optical design collapses.

PS1≈k1x+PSi1 Expression (2)

PS2≈k2x+PSi2 Expression (3)

Here, PS1 denotes a difference in focal length in the T-plane, and PS2 is a difference in focal length in the S-plane. Moreover, k1 denotes a degree of sensitivity at which the difference in focal length varies per unit of movement amount in the plane perpendicular to the optical axis L in the T-plane (hereinafter referred to as sensitivity k1), and k2 denotes a degree of sensitivity at which the difference in focal length varies per unit of movement amount in the plane perpendicular to the optical axis L in the S-plane (hereinafter, referred to as sensitivity k2). Moreover, x denotes an amount of movement (the amount of positional adjustment) of the adjusted lens 111 in the plane perpendicular to the optical axis L, PSi1 denotes the difference in focal length before adjustment in the T-plane, and PSi2 denotes the difference in focal length before adjustment in the S-plane.

Based on Expression (2) and Expression (3), Expression (4) below needs to be satisfied in order to eliminate image plane tilts in the T-plane and S-plane, that is, in order to render PS1 and PS2 zero simultaneously, by moving the adjusted lens horizontally.

x=−PSi1/k1=−PSi2/k2 Expression (4)

However, satisfying PSi1/k1=PSi2/k2 is difficult in reality. This is because that k1 and k2, which are determined by optical design, are not different among the individual imaging lenses 110 of the same standard, whereas PSi1 and PSi2, which have variations in a production process, take various values among the individual imaging lenses 110.

Accordingly, the imaging-lens manufacturing apparatus 100 rotates the adjusted lens 111 about the rotation center point RC to adjust the angle of the adjusted lens 111 with respect to the optical axis L, in addition to making a positional adjustment to the adjusted lens 111 in the plane perpendicular to the optical axis L. The imaging-lens manufacturing apparatus 100 can consequently adjust the adjusted lens 111 so as to eliminate the image plane tilts in the T-plane and S-plane and can then manufacture the imaging lens 110.

As described earlier, the tilt PS is substantially in linear relation to the amount of movement in the positional movement of the adjusted lens 111 in the plane perpendicular to the optical axis L; for the tilt angle of the adjusted lens 111, a similar relation is established. That is, Expression (5) and Expression (6) below are established.

PS1≈k3t+PSi1 Expression (5)

PS2≈k4t+PSi2 Expression (6)

Here, PS1 denotes a difference in focal length in the T-plane, and PS2 is a difference in focal length in the S-plane.

Further, k3 denotes a degree of sensitivity at which the difference in focal length varies per unit of rotation amount in the T-plane (hereinafter, referred to as sensitivity k3), and k4 denotes a degree of sensitivity at which the difference in focal length varies per unit of rotation amount in the S-plane (hereinafter, referred to as sensitivity k4). Moreover, t denotes the amount of rotation of the adjusted lens 111. PSi1 denotes the difference in focal length before adjustment in the T-plane, and PSi2 is the difference in focal length before adjustment in the S-plane.

It should be noted that the sensitivity k3 and the sensitivity k4 include a PS varying component resulting from a positional movement in the plane perpendicular to the optical axis L, which is generated by the amount of rotation of the adjusted lens 111. The details will be described later on.

The positional movement of the adjusted lens 111 in the plane perpendicular to the optical axis L of the adjusted lens 111 and the rotation of the adjusted lens 111 cause PS1 and PS2 to vary independently of each other. That is, based on Expression (2), Expression (3), Expression (5) and Expression (6), Expression (7) and Expression (8) below are established.

PS1≈(k1x+k3t)+PSi1 Expression (7)

PS2≈(k2x+k4t)+PSi2 Expression (8)

Accordingly, to render the image plane tilts in the T-plane and S-plane, that is, PS1 and PS2, zero simultaneously, a system of simultaneous equations of Expression (9) and Expression (10) below needs to be solved to determine a positional-adjustment amount x of the adjusted lens 111 in the plane perpendicular to the optical axis L (hereinafter, referred to as in-plane adjustment amount x), and a rotational-adjustment amount t of the adjusted lens 111.

PSi1−(k1x+k3t)=0 Expression (9)

PSi2−(k2x+k4t)=0 Expression (10)

By the way, the adjusted lens 111, upon being rotated, moves to a location in the plane perpendicular to the optical axis L, thus changing the PS value. Hence, the sensitivity k3 and sensitivity k4 of the PS amount, both of which vary per unit of rotation amount, need to include a PS varying component as well resulting from a positional movement in the plane perpendicular to the optical axis L, which is generated by the amount of rotation of the adjusted lens 111, as earlier described.

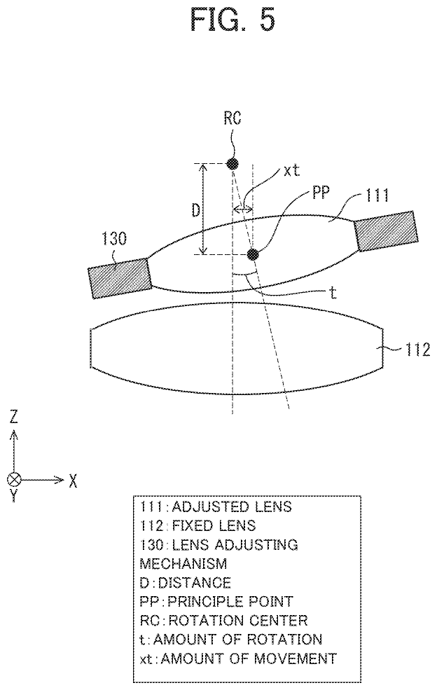

The following details the foregoing. FIG. 5 illustrates an example distance D in the direction of the optical axis L from the principle point, PP, of the adjusted lens 111 to the rotation center point RC. As illustrated in FIG. 5, when the adjusted lens 111 rotates, its location in the plane perpendicular to the optical axis L moves as indicated in Expression (11) below, depending on the position of the rotation center point RC.

xt=D sin t Expression (11)

Here, D denotes a distance in the direction of the optical axis L from the principle point PP of the adjusted lens 111 to the rotation center point RC (hereinafter, referred to as a distance D), xt denotes the amount of movement of the adjusted lens 111 in the plane perpendicular to the optical axis L in response to a rotation of the adjusted lens 111 (hereinafter, referred to as a rotational-movement amount xt), and, t denotes the amount of rotation of the adjusted lens 111. For D=1 mm as well as t=0.2 degrees for instance, the rotational-movement amount xt stands at about 3.5 μm.

To reduce an adjustment error in the adjusted lens 111, the in-plane adjustment amount x is desirably more predominant than the rotational-movement amount xt. The rotational-movement amount xt hence needs to satisfy Expression (12) below.

|x/xt|≥1 Expression (12)

When the rotational-movement amount xt does not satisfy Expression (12), or when a solution cannot be obtained from the system of simultaneous equations of Expression (9) and Expression (10), the control unit 180 adjusts the rotation center point RC to change the distance in the direction of the optical axis L from the principle point PP of the adjusted lens 111 to the rotation center point RC and to adjust the rotational-movement amount xt. The method of adjustment will be descried later on.

Calculation of Degree of Sensitivity at which Difference in Focal Length Varies Per Unit of Rotation Amount

The distance D is a main factor for causing the sensitivity k3 in Expression (9) and the sensitivity k4 in Expression (10) to vary, as earlier described.

As a matter of course, the sensitivity k3 and the sensitivity k4 are desirably invariable constants. However, the distance D varies depending on the specifications of the imaging-lens manufacturing apparatus 100, or the environment in which the imaging-lens manufacturing apparatus 100 manufactures the imaging lens 110 and cannot be hence kept constant in some cases.

In other words, it is difficult in some cases to keep the value of the sensitivity k3 in Expression (9) and the value of the sensitivity k4 in Expression (10) constant in actual production. Conceivable cases in which these values are difficult to keep constant include, but not limited to, a case in which it is difficult to bring the adjustment in a plurality of imaging-lens manufacturing apparatuses 100 into uniformity, and a case in which the imaging-lens manufacturing apparatus 100 changes its condition during operation. Further conceivable cases include, but not limited to, a case in which height for holding the adjusted lens 111 varies every time in the process of manufacturing the imaging lens 110, and a case in which the height of the principle point PP is too different between the adjusted lenses 111 to be ignored.

Accordingly, the control unit 180 calculates the sensitivity k3, at which the difference in focal length varies per unit of rotation amount in the tangential image plane, and the sensitivity k4, at which the difference in focal length varies per unit of rotation amount in the sagittal image plane, by rotating the adjusted lens 111 about the rotation center point RC by a predetermined angle tc.

That is, the control unit 180 calculates the sensitivity k3 and sensitivity k4 that are inherent in the imaging-lens manufacturing apparatus 100, by rotating the adjusted lens 111 by the predetermined angle tc. Although the predetermined angle tc can be determined freely, the predetermined angle tc preferably satisfy |tc|<1 degree because an excessively large angle can produce an error. The predetermined angle tc can be set at 0.5 degrees in the θX-direction for instance.

The control unit 180 firstly performs defocus MTF measurement on the imaging lens 110 before adjustment and calculates the tilt PSi1 in the T-plane and the tilt PSi2 in the S-plane for this not-yet-adjusted imaging lens 110. The control unit 180 rotates, by the predetermined angle tc, the adjusted lens 111 of the imaging lens 110 with the tilts PSi1 and PSi2 calculated. The control unit 180 performs defocus MTF measurement on the imaging lens 110 with the adjusted lens 111 rotated by the predetermined angle tc. The control unit 180 then calculates the tilt PS with the adjusted lens 111 rotated by the predetermined angle tc, that is, a tilt PS1c in the T-plane with the adjusted lens 111 rotated by the predetermined angle tc, and a tilt PS2c in the S-plane with the adjusted lens 111 rotated by the predetermined angle tc.

For the adjusted lens 111 rotated by the predetermined angle tc, the following relationships are established based on Expression (7) and Expression (8).

PS1c≈(k1x+k3tc)+PSi1 Expression (7-1)

PS2c≈(k2x+k4tc)+PSi2 Expression (8-1)

Here in Expression (7-1) and Expression (8-1), tc is known, PS1c, PS2c, PSi1 and PSi2 are known from optical-performance measurement, k1 and k2 are known as being invariable from designed values, and k3 and k4 are unknown parameters.

The control unit 180 thus solves Expression (7-1) and Expression (8-1) above and identifies the sensitivity k3 and the sensitivity k4 on the basis of Expression (13) and Expression (14) below, to thus calculate the sensitivity k3 and the sensitivity k4.

k3=(PS1c−PSi1)/tc Expression (13)

k4=(PS2c−PSi2)/tc Expression (14)

### Adjustment of Rotation Center Point RC

The control unit 180 adjusts the position of the rotation center point RC when, as earlier described, Expression (12) is not satisfied, or when a solution cannot be obtained from the system of simultaneous equations of Expression (9) and Expression (10). To be specific, the control unit 180 calculates a distance r in the direction of the optical axis L from the principle point PP of the adjusted lens 111 to the rotation center point RC that is in its proper position (hereinafter, referred to as a distance r), to thus derive the position of the rotation center point RC that is in its proper position. The distance r is calculated from Expression (15) below.

r=(k3tc−k3ctc)/(k1 sin tc) Expression (15)

Here, tc denotes a predetermined angle for rotating the adjusted lens 111 about the rotation center point RC. In addition, k3 denotes a degree of sensitivity at which the difference in focal length varies per unit of rotation amount in the tangential image plane, and k1 denotes a degree of sensitivity at which the difference in focal length varies per unit of movement amount in the plane perpendicular to the optical axis in the tangential image plane. In addition, k3c denotes a degree of sensitivity at which the difference in focal length varies per unit of rotation amount in the tangential image plane when the position of the rotation center point RC coincides with the position of the principle point PP of the adjusted lens 111 (i.e., in the case of the distance r=0) (hereinafter, referred to as a sensitivity k3c). The sensitivity k3c, like the sensitivity k1 and sensitivity k2, is a designed value of the adjusted lens 111 and is a lens-inherent constant that does not vary depending on the environment.

The following describes a process of deriving Expression (15). Based on xt=rsin t, obtained by substituting r into D in Expression (11), the rotational-movement amount xt, which is produced upon the adjusted lens 111 being rotated by the predetermined angle tc, is expressed by Expression (11-1).

xt=r×sin tc Expression (11-1)

A multiplication by the sensitivity k1 offers Expression (11-2), where ΔPS is Tan PS based on foregoing xt.

ΔPS=rk1 sin tc Expression (11-2)

In Expression (11-2), ΔPS=0 is established when r=0 is established. Further, the values of k1 and PSi1 in Expression (7) do not change even when the value of the distance r changes.

When x is equal to zero, the difference between PS1c, which corresponds to PS in neither t=tc nor r=0, and PS1c′, which corresponds to PS in t=tc and r=0, is only PS based on xt produced upon tc-tilt, that is, ΔPS. Thus, Expression (11-3) below is established.

PS1c−PC1c′=ΔPS Expression (11-3)

Based on Expression (11) and x=0 as well as Expression (11-2), Expression (11-4) below is established.

k3tc−k3ctc=rk1 sin tc Expression (11-4)

This derives Expression (15): r=(k3tc−k3ctc)/(k1 sin tc).

The control unit 180 adjusts the position of the rotation center point RC in such a manner that the distance r is satisfied. The control unit 180 may adjust the position of the rotation center point RC on the basis of the difference between the distance r and the distance in the direction of the optical axis L from the principle point PP of the adjusted lens 111 to the rotation center point RC with the adjusted lens 111 rotated by the predetermined angle tc. It is noted that the position of the rotation center point RC at the time of rotating the adjusted lens 111 by the predetermined angle tc is determined by, but not limited to, actual values in the past.

The control unit 180 may adjust the rotation center point RC through manual apparatus operation. The control unit 180 may also include an auto-adjustment mechanism, not shown, for the rotation center point RC and may adjust the rotation center point RC automatically. This enables prompt adjustment after the calculation of the distance r, thereby enabling continuous operation without stopping the imaging-lens manufacturing apparatus 100 for a long time for adjusting the rotation center point RC.

Further, the distance r is desirably adjusted within 0 mm≤r≤6 mm. This is because that if the distance r is smaller than zero, the adjusted lens 111 and the fixed lens 112 might collide against each other due to the rotation of the adjusted lens 111, and that if the distance r is larger than 6 mm, Expression (12) is difficult to satisfy.

For instance, when the in-plane adjustment amount x of the adjusted lens 111 is equal to 100 μm, and when the rotational-adjustment amount t of the adjusted lens 111 is equal to 1 degree, r≤(x/sin t) is established based on Expression (11) and Expression (12), and the upper limit of the distance r satisfying Expression (12) stands at about 5.7 mm. It is noted that the distance D in Expression (11) is defined herein as the distance r.

The limits of the in-plane adjustment amount x of the adjusted lens 111 and of the rotational-adjustment amount t of the adjusted lens 111 conceivably stand at about 100 μm and about 1 degree, respectively. This is because that if adjustment amounts exceeding these limits are necessary, the imaging lens 110 for use in a smartphone or other things, which normally needs to be assembled with strict accuracy, exhibits no optical performance at all, and the tilt PS cannot be measured. Hence, the distance r is desirably adjusted within 0 mm r 6 mm.

### Setting of Adjustment Image Height

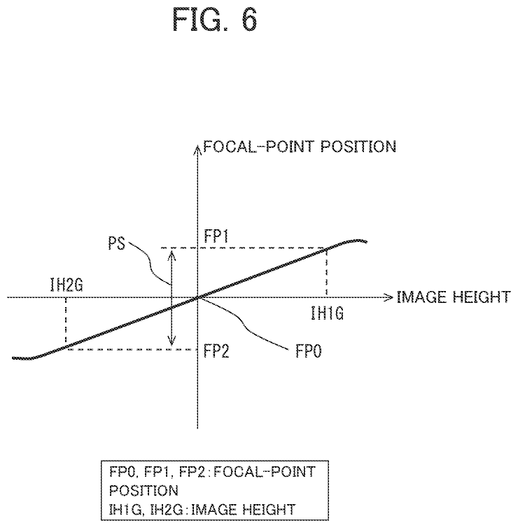

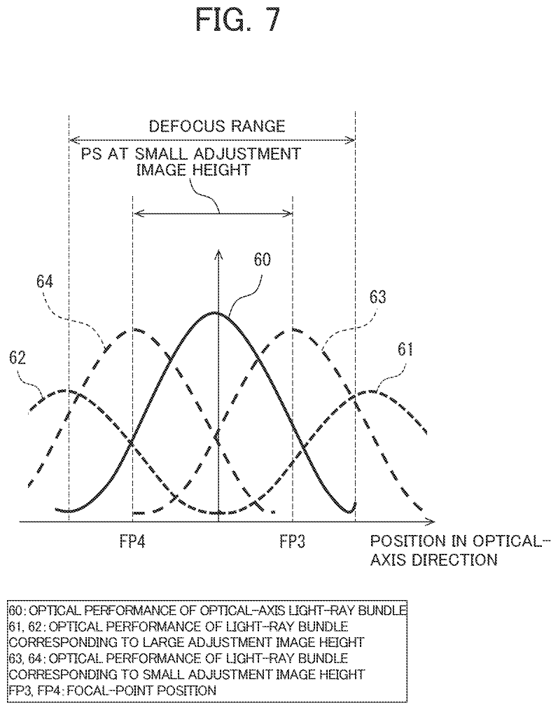

Setting an adjustment image height relates to a calculation of an image plane tilt. The setting of an adjustment image height will be described with reference to FIG. 6 and FIG. 7. FIG. 6 schematically illustrates the relationship between a tilt PS and a focal-point position. The lateral axis in FIG. 6 indicates the position of an image height on an ideal image plane, and the longitudinal axis in the same indicates a focal-point position in the direction of the optical axis L. FP0, FP1, and FP2 in FIG. 6 are respectively the focal-point position of the optical-axis light-ray bundle RIH0 in FIG. 4, the focal-point position of the light-ray bundle RIH1 in FIG. 4, and the focal-point position of the light-ray bundle RIH2 in FIG. 4. Further, image heights IH1G and IH2G in FIG. 6 are in-focus points on the ideal image planes of the light-ray bundle RIH1 and light-ray bundle RIH2 in the case of no tilt in their image planes and coincide with an adjustment image height.

The tilt PS is the difference between the focal-point position FP1 and the focal-point position FP2, as illustrated in FIG. 6. It is hence obvious that the absolute value of the tilt PS increases along with increase in the adjustment image height even when the image planes are tilted at the same angle. In other words, the sensitivity of the tilt PS with respect to the amount of adjustment of the adjusted lens 111 increases along with increase in the adjustment image height, because an effect resulting from a tilt of an image plane is exerted more easily as an adjustment image height gets higher. A greater adjustment image height offers higher accuracy; thus, this is preferable in calculating the amount of adjustment of the adjusted lens 111.

The absolute value of the adjustment image height for determining the tilt PS is desirably 60% or greater of the radius of the image circle of the imaging lens 110. Further, 100% (maximum image height), which is the end of the image circle of an optical system, or greater increases various tolerances in typical optical design, thereby possibly causing deterioration in adjustment accuracy in obtaining a focal-point position. It is hence preferable that the adjustment image height be 60 to 90% of the radius of the image circle.

However, an adjustment to the adjusted lens 111 based on an adjustment image height of 60% or greater of the radius of the image circle (a first adjustment image height, hereinafter, referred to as a large adjustment image height) increases the sensitivity of the tilt PS, thus causing the following problem. That is, a large amount of adjustment is required for the adjusted lens 111 when, for instance, the placement position of the adjusted lens 111 before adjustment is deviated greatly from the optical axis L of the fixed lens 112. If the focal-point position FP1 and the focal-point position FP2 are off from a defocus range in this case, an MTF cannot be evaluated, thus possibly failing to detect an image plane tilt.

A possible way to address this problem is widening the defocus range; however, this increases the time for production in the imaging-lens manufacturing apparatus 100, thus lowering production efficiency.

Even if the defocus range is widened, a large tilt PS typically tends to lower the values of an MTF at a large adjustment image height, thus lowering the accuracy of detection of the focal-point position FP1 and focal-point position FP2 considerably.

Accordingly, it is effective to adjust the adjusted lens 111 at 10 to 50% of the radius of the image circle (a second adjustment image height, hereinafter, referred to as a small adjustment image height) when the tilt of the image plane cannot be detected at a large adjustment image height.

FIG. 7 is a schematic diagram showing, in each light-ray bundle, the relationship between a location in the direction of the optical axis L and optical performance. The lateral axis in FIG. 7 indicates the location in the direction of the optical axis L, and the longitudinal axis in the same indicates the optical performance. The following describes FIG. 7 using, by way of example, the imaging-lens manufacturing apparatus 100 illustrated in FIG. 1.

A graph 70 in FIG. 7 indicates the optical performance in a location in the direction of the optical axis L of the optical-axis light-ray bundle RL illustrated in FIG. 1. Here, an MTF is applicable to the optical performance. Graphs 61 and 62 in FIG. 7 indicate the optical performance in a location in the direction of the optical axis L of the pair of first light-ray bundles Ra illustrated in FIG. 1. Graphs 63 and 64 in FIG. 7 indicate the optical performance in a location in the direction of the optical axis L of the pair of second light-ray bundles Rb illustrated in FIG. 1. That is, the graphs 61 and 62 in FIG. 7 indicate the optical performance of the first light-ray bundles Ra corresponding to the large adjustment image height, and the graphs 63 and 64 in FIG. 7 indicate the optical performance of the second light-ray bundles Rb corresponding to the small adjustment image height.

In the graphs 60 to 64, locations in which the optical performance is maximum in the direction of the optical axis L are the focal-point positions of the respective light-ray bundles, among which the focal-point position FP3 and the focal-point position FP4 indicate the focal-point positions of the pair of respective second light-ray bundles Rb corresponding to the small adjustment image height.

FIG. 7 shows a tilt PS calculated based on the second light-ray bundles Rb, which correspond to the small adjustment image height, and shows a defocus range. As illustrated in FIG. 7, the sensitivity at the small adjustment image height is small relative to the amount of adjustment of the adjusted lens 111, and thus, the focal-point position FP3 and the focal-point position FP4 (the tilt PS based on the small adjustment image height) are less likely to deviate from the defocus range. Further, the degradation in the optical performance is relatively small, and thus, the focal-point position FP3 and the focal-point position FP4 are easy to detect.

In this preferred embodiment, the sensors 121 and the slits 151 are disposed not only in locations corresponding to the large adjustment image height, but also in locations corresponding to the small adjustment image height. This enables the tilt PS to be obtained simultaneously for the two adjustment image heights through a one-time defocus action, thus enabling more accurate adjustment.

Further, when, for instance, the tilt value PS at the large adjustment image height exceeds a predetermined threshold, or when, for instance, the tilt PS cannot be measured at the large adjustment image height, the foregoing configuration enables the adjusted lens 111 to be adjusted in accordance with the amount of adjustment calculated based on the tilt PS at the small adjustment image height.

Further, separating the adjustment of the adjusted lens 111 into two or more times: rough adjustment and main adjustment, for the respective large adjustment image height and small adjustment image height, can prevent the amount of adjustment in the rough adjustment. This enables the imaging lens 110 to be adjusted accurately while preventing the defocus range even when a large amount of adjustment is required.

### Method for Manufacturing Imaging Lens

The following describes how to achieve the manufacture of the imaging lens 110 by the use of the imaging-lens manufacturing apparatus 100 according to this preferred embodiment. It is noted that there are two kinds of adjustment image heights in the following example: a large adjustment image height and a small adjustment image height, and that an MTF that is used for the adjustment is detected at four points on individual concentric circles for each adjustment image height. That is, nine sensors 121 are disposed in a manner similar to that in the imaging-lens manufacturing apparatus 100 illustrated in FIG. 1, and the slits 151, disposed in the reticle 150, are disposed in correspondence with these sensors 121. It is noted that the large adjustment image height is an adjustment image height (first adjustment image height) of 60% or greater of the radius of the image circle, and the small adjustment image height is an image height (second adjustment image height) of 10 to 50% of the radius of the image circle.

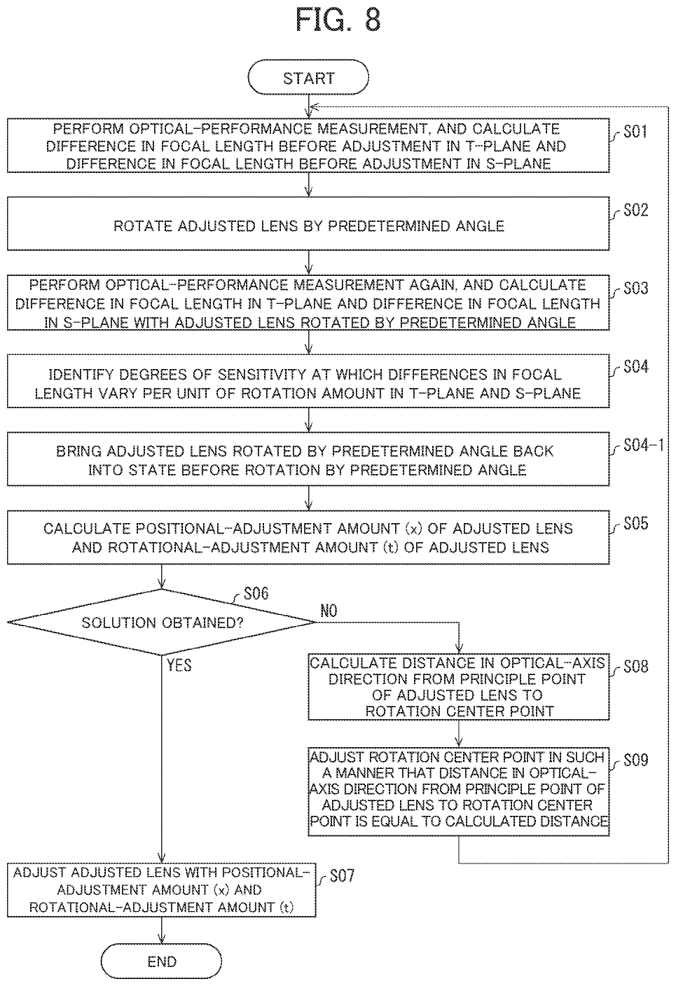

FIG. 8 is a flowchart showing, by way of example, how the imaging-lens manufacturing apparatus 100 according to this preferred embodiment manufactures the imaging lens 110.

In Step S01, the control unit 180 performs optical-performance measurement (defocus MTF measurement) on the imaging lens 110. In more detail, the light detecting unit 120 firstly detects light-ray bundles passed through the slits 151 every time the defocus mechanism 170 defocuses the imaging lens 110 little by little.

The control unit 180 next derives the MTFs in the T-plane and S-plane as the optical performance of the imaging lens 110, for an image formed by each light-ray bundle detected by the light detecting unit 120. The control unit 180 then calculates, from focal-point positions calculated based on the MTFs, a difference PSi1 in focal length before adjustment in the T-plane corresponding to the tilt of the T-plane before adjustment, and a difference PSi2 in focal length before adjustment in the S-plane corresponding to the tilt of the S-plane before adjustment.

In Step S02, the control unit 180 controls the lens adjusting mechanism 130 to rotate the adjusted lens 111 by the predetermined angle tc. It is noted that the rotation center point RC at this time is determined by, but not limited to, actual values in the past.

In Step S03, the control unit 180 performs optical-performance measurement (defocus MTF measurement) on the imaging lens 110 again with the adjusted lens 111 rotated by the predetermined angle tc. The control unit 180 calculates a difference PS1c in focal length in the T-plane, and a difference PS2c in focal length in the S-plane, with the adjusted lens 111 rotated by the predetermined angle tc.

In Step S04, the control unit 180 identifies the sensitivity k3 and the sensitivity k4 by using Expression (13) and Expression (14).

Thereafter in Step S04-1, the adjusted lens 111 rotated by the predetermined angle tc is brought back into a state before rotation by the predetermined angle tc (state in S01).

In Step S05, the control unit 180 determines the in-plane adjustment amount x that satisfies Expression (12) and the rotational-adjustment amount t by solving the system of simultaneous equations of Expression (9) and Expression (10). It is noted that in Step S05, the values calculates in Step S04 are substituted into k3 and k4 in Expression (9) and Expression (10), and that in Step S05, PSi1 and PSi2 calculated in Step S01 are substituted into PSi1 and PSi2 in Expression (9) and Expression (10).

Further, the foregoing procedure, i.e., Step S02 through Step S05, is a procedure for implementing the in-plane adjustment amount x and rotational-adjustment amount t of the adjusted lens 111 in either one (e.g., the X-axis direction) of two mutually perpendicular axial directions (the X-axis direction and the Y-axis direction) in the plane perpendicular to the optical axis L. However, the pairs of sensor 121 and slit 151 are disposed in each of the X-axis direction and Y-axis direction. Thus, the in-plane adjustment amount x and rotational-adjustment amount t of the adjusted lens 111 in not only either one of the axial directions (e.g., X-axis direction), but also the other axial direction (e.g., Y-axis direction) is calculated simultaneously.

Next in Step S06, the control unit 180 determines whether the solutions of the in-plane adjustment amount x and rotational-adjustment amount t have been obtained in Step S05. If the solutions of the in-plane adjustment amount x and rotational-adjustment amount t have been obtained in Step S05 (if YES in Step S06), the lens adjusting mechanism 130, in Step S07, adjusts the in-plane adjustment amount x and rotational-adjustment amount t of the adjusted lens 111 from a state where the adjusted lens 111 has been brought back into the state before rotation by the predetermined angle tc (i.e., from the state in S01).

In contrast, if the solutions of the in-plane adjustment amount x and rotational-adjustment amount t have not obtained in Step 05 (if NO in Step 06), the control unit 180 calculates the distance r in Step S08 on the basis of Expression (15). Next in Step S09, with the adjusted lens 111 back into the state before rotation by the predetermined angle tc (i.e., in the state in S01), the control unit 180 adjusts the rotation center point RC in such manner that the distance in the direction of the optical axis L from the principle point PP of the adjusted lens 111 to the rotation center point RC is equal to the calculated distance r, and the control unit 180 then returns to the process step in Step S01.

It is noted that this manufacturing method may include, before Step S01, separating the adjusted lens 111 of the imaging lens 110 from the fixed lens 112.

### Second Preferred Embodiment

The following describes an imaging-lens manufacturing apparatus 200 according to a second preferred embodiment of the present invention. It is noted that for convenience in description, components having the same functions as components described in the first preferred embodiment will be denoted by the same signs, and that their description will not be repeated. It is also noted that an image height, how a control unit 180A determines an image plane tilt in the imaging lens 110, how to calculate the amount of adjustment of the adjusted lens 111 from the image plane tilt, and how to adjust the adjusted lens 111, all of which are similar to those in the first preferred embodiment, will not be described.

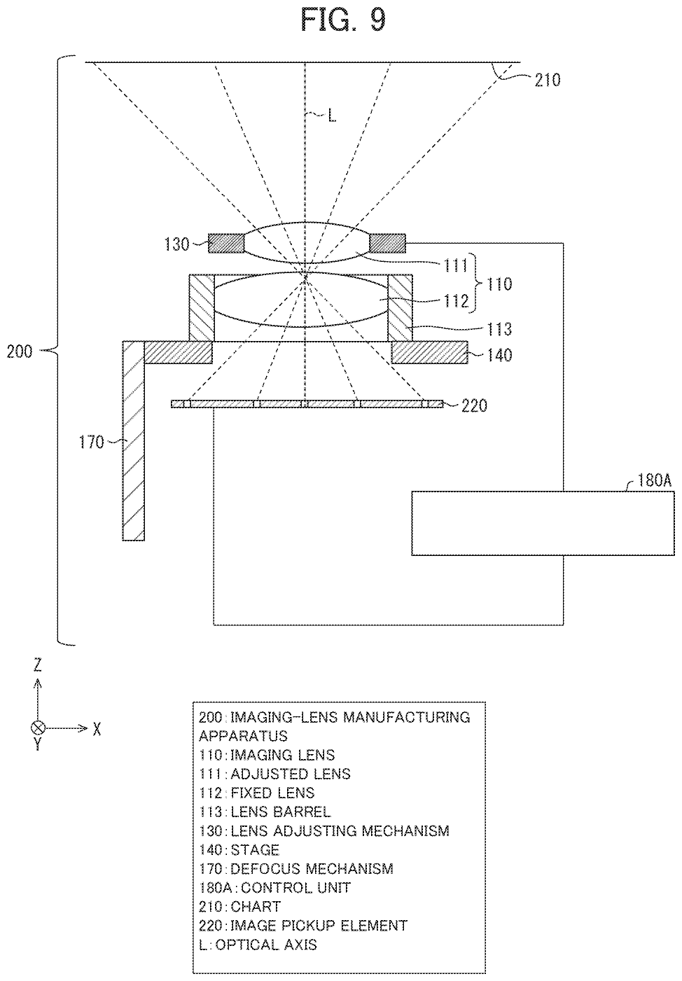

FIG. 9 is a schematic diagram of an example configuration of the imaging-lens manufacturing apparatus 200 according to the second preferred embodiment of the present invention. As illustrated in FIG. 9, the imaging-lens manufacturing apparatus 200 is the same as the imaging-lens manufacturing apparatus 100 with the exception that the imaging-lens manufacturing apparatus 200 includes a chart 210, an image pickup element 220 and the control unit 180A instead of the light detecting unit 120, reticle 150, light source 160 and control unit 180.

This configuration enables the adjusted lens 111 to be adjusted on the basis of an output from the image pickup element 220, thereby achieving the adjustment of the adjusted lens 111 under a condition closer to a product.

### Imaging-Lens Manufacturing Apparatus 200

The imaging-lens manufacturing apparatus 200 is an apparatus that manufactures the imaging lens 110 provided with a plurality of lenses including the adjusted lens 111, which is used in assembly.

Further, the imaging-lens manufacturing apparatus 200 includes the lens adjusting mechanism 130, the stage 140, the defocus mechanism 170, the control unit 180A, the chart 210, and the image pickup element 220. The lens adjusting mechanism 130, the stage 140, and the defocus mechanism 170 have their functions similar to those in the imaging-lens manufacturing apparatus 100.

In the chart 210 is chart patterns 211 (patterns) formed so that the optical performance in the tangential direction and sagittal direction of the imaging lens 110 is evaluable.

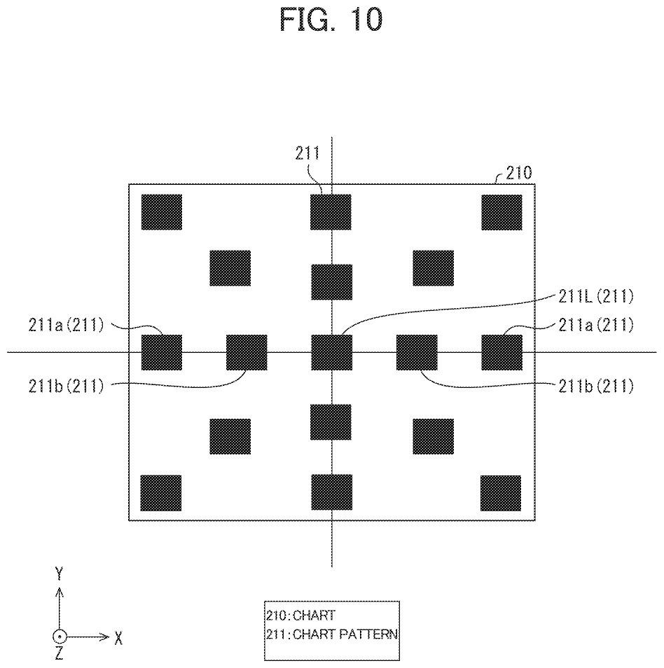

FIG. 10 is a top view of an example of the chart 210 of the imaging-lens manufacturing apparatus 200. As illustrated in FIG. 10, the chart 210 has a plurality of chart patterns 211. FIG. 10 illustrates a non-limiting instance where the chart patterns 211 are each formed in the form of a rectangle. The chart patterns 211 need to determine the optical performance in the tangential direction and sagittal direction directly or indirectly through calculation and each may have any size and any shape. For instance, the chart patterns 211 each may have a trapezoidal shape or a circular shape.

The chart patterns 211 are arranged in such a manner for instance, that a single chart pattern 211 is disposed in a location at the central image height of the imaging lens 110, and that the other chart patterns 211 are disposed in locations at the peripheral image heights of the imaging lens 110.

To be specific, the chart patterns 211 include a chart pattern 211L disposed in a location on the optical axis L, and the other chart patterns 211 located at the peripheral image heights. The other chart patterns 211, located at the peripheral image heights, form pairs. FIG. 10 illustrates a pair of chart patterns 211a and a pair of chart patterns 211b as an example of a plurality of pairs of chart patterns 211. The chart patterns 211a in a pair are symmetric with respect to the optical axis L, and the chart patterns 211b in a pair are likewise symmetric with respect to the optical axis L. For instance, the pair of chart patterns 211a may be disposed at a first adjustment image height (an adjustment image height of 60% or greater of the radius of an image circle), and the pair of chart patterns 211b may be disposed at a second adjustment image height (an adjustment image height of 10 to 50% of the radius of the image circle). However, the number of chart patterns 211 is not limited to what is illustrated in the drawing; the chart patterns 211 need to include the chart pattern 211L and at least one pair of chart patterns 211.

The chart 210 is disposed in a predetermined location with respect to the imaging lens 110 and is fixed to a fixed portion, not shown, of the imaging-lens manufacturing apparatus 200.

The image pickup element 220 takes an image of the chart 210 through the imaging lens 110. The image pickup element 220 is disposed opposite the chart 210 with respect to the imaging lens 110. The image pickup element 220 is disposed so as to be able to take an image of each chart pattern 211 and takes an image of each chart pattern 211 via the imaging lens 110. The image pickup element 220 outputs data of the taken images of the chart patterns 211 to the control unit 180A.

The control unit 180A controls the defocus mechanism 170 to derive, while performing defocus, the optical performance of the imaging lens 110 from signals output from the image pickup element 220. The control unit 180A also calculates differences in focal length in the tangential image plane and sagittal image plane on the basis of the derived optical performance and controls the lens adjusting mechanism 130 on the basis of the calculated differences in focal length in the tangential image plane and sagittal image plane.

To be specific, the control unit 180A derives a spatial frequency response (SFR) as the optical performance of the imaging lens 110 from the taken-image data of the chart patterns 211 output from the image pickup element 220. Here, an MTF and a SFR, although detected by mutually different means, are both indices for evaluating the optical performance (resolution); in the present invention, the MTF and the SFR are regarded as equivalent measurement indices for evaluating the optical performance.

The control unit 180A also controls the defocus mechanism 170 to drive the stage 140, and to derive, while performing defocus, the optical performance of the imaging lens from the signals output from the image pickup element 220, so that the control unit 180A can evaluate an SFR corresponding to the defocus. The control unit 180A can consequently acquire focal information at an adjustment image height of the imaging lens 110.

The control unit 180A can further determine the amount of adjustment of the adjusted lens 111 from an image plane tilt of the imaging lens 110 and controls the lens adjusting mechanism 130 to adjust the imaging lens 110 with regard to the amount of adjustment of the imaging lens 110 determined by the control unit 180A.

### Method for Manufacturing Imaging Lens

With reference to FIG. 8, the following describes how to achieve the manufacture of the imaging lens 110 by the use of the imaging-lens manufacturing apparatus 200 according to this preferred embodiment. It is noted that the following describes an instance where the chart patterns 211 are disposed at a large adjustment image height and a small adjustment image height, and where an SFR that is used for the adjustment is detected at four points on individual concentric circles for each adjustment image height. That is, nine chart patterns 211 are disposed, and the image pickup element 220 is disposed so as to be able to take an image of each chart pattern.

How to manufacture the imaging lens 110 by the use of the imaging-lens manufacturing apparatus 200 is similar to that by the use of the imaging-lens manufacturing apparatus 100 with the exception that Steps S01 and S03 in the imaging-lens manufacturing apparatus 200 are different from those in the imaging-lens manufacturing apparatus 100.

In Step S01, the control unit 180A performs optical-performance measurement (defocus SFR measurement) on the imaging lens 110. In more detail, the image pickup element 220 takes images of the chart patterns 211 every time the defocus mechanism 170 defocuses the imaging lens 110 little by little.

The control unit 180A next derives, about the image data of the chart patterns 211 taken by the image pickup element 220, SFRs in the T-plane and S-plane as the optical performance of the imaging lens 110. The control unit 180A then calculates, from focal-point positions calculated based on the SFRs, a difference PSi1 in focal length before adjustment in the T-plane corresponding to the tilt of the T-plane before adjustment, and a difference PSi2 in focal length before adjustment in the S-plane corresponding to the tilt of the S-plane before adjustment.

In Step S02, the control unit 180A controls the lens adjusting mechanism 130 to rotate the adjusted lens 111 by a predetermined angle tc.

In Step S03, the control unit 180A performs optical-performance measurement (defocus SFR measurement) on the imaging lens 110 again with the adjusted lens 111 rotated by the predetermined angle tc. The control unit 180A calculates a difference PS1c in focal length in the T-plane, and a difference PS2c in focal length in the S-plane, with the adjusted lens 111 rotated by the predetermined angle tc. The subsequent process steps, i.e., Steps S04 through Step S09, are similar to those in the first preferred embodiment.

### Third Preferred Embodiment

The following describes a camera-module manufacturing apparatus 300 according to a third preferred embodiment of the present invention. It is noted that for convenience in description, components having the same functions as components described in the foregoing preferred embodiments will be denoted by the same signs, and that their description will not be repeated. It is also noted that an image height, how the control unit 180A determines an image plane tilt in the imaging lens 110, how to calculate the amount of adjustment of the adjusted lens 111 from the image plane tilt, and how to adjust the adjusted lens 111, all of which are similar to those in the foregoing preferred embodiments, will not be described.

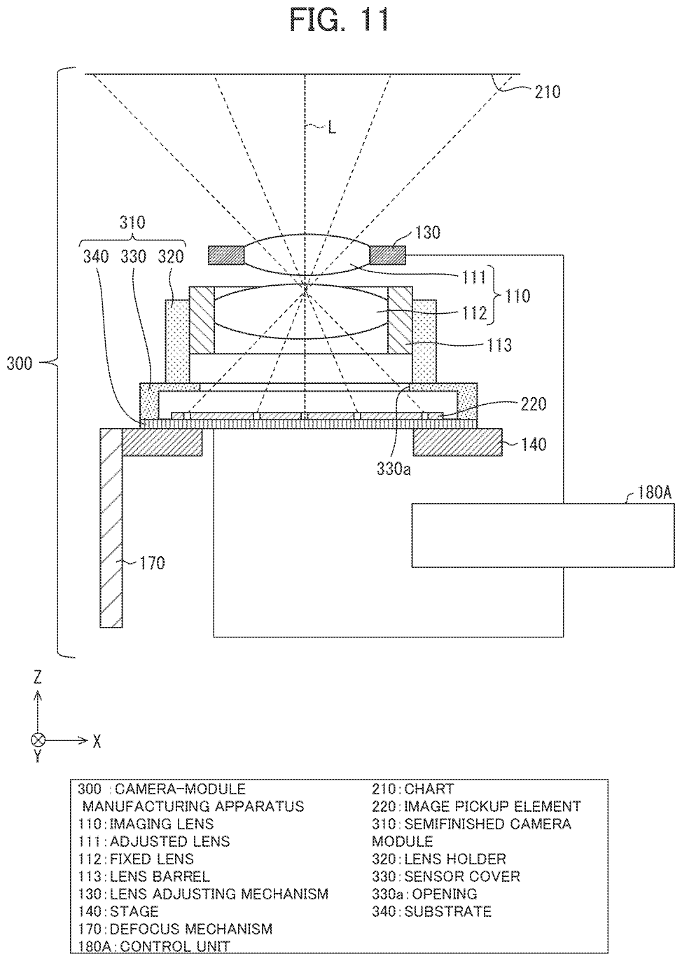

FIG. 11 is a schematic diagram of an example configuration of the camera-module manufacturing apparatus 300 according to the third preferred embodiment of the present invention. As illustrated in FIG. 11, the camera-module manufacturing apparatus 300 is the same as the imaging-lens manufacturing apparatus 200 with the exception that the camera-module manufacturing apparatus 300 adjusts, for a semifinished camera module 310, optical performance with the adjusted lens 111.

This preferred embodiment enables an adjustment into the best optical performance in a finished camera module. This can achieve the camera-module manufacturing apparatus 300 that can manufacture a camera module provided with a higher-accuracy imaging lens with a reduced tilt of each of the tangential image plane and sagittal image plane.

### Camera-Module Manufacturing Apparatus 300

The camera-module manufacturing apparatus 300 manufactures a camera module having the following: the imaging lens 110 provided with a plurality of lenses including the adjusted lens 111 that is used in assembly; and the image pickup element 220.

As earlier described, the camera-module manufacturing apparatus 300 is an apparatus that adjusts, for the semifinished camera module 310, the optical performance with the adjusted lens 111, and that manufactures a camera module. The camera-module manufacturing apparatus 300 includes the lens adjusting mechanism 130, the stage 140, the defocus mechanism 170, the control unit 180A, and the chart 210. The lens adjusting mechanism 130, the stage 140, the defocus mechanism 170, the control unit 180A and the chart 210 have their functions similar to those in the imaging-lens manufacturing apparatus 200.

The semifinished camera module 310 includes the imaging lens 110, the lens barrel 113, the image pickup element 220, a lens holder 320, a sensor cover 330, and a substrate 340.

The lens holder 320 has an inner surface on which the lens barrel 113, which holds the fixed lens 112, are fixed with an adhesive, and the lens holder 320 holds the fixed lens 112. The lens holder 320 is fixed to the upper surface of the sensor cover 330. Further, the sensor cover 330 is fixed to the stage 140 with the substrate 340 interposed therebetween. Accordingly, the stage 140 holds the semifinished camera module 310. The stage 140 also holds at least the fixed lens 112.

The lens holder 320 may serve as an actuator for driving the imaging lens 110 in the direction of the optical axis L or a direction perpendicular to the direction of the optical axis L. The imaging lens 110 drives in the direction of the optical axis L or the direction perpendicular to the direction of the optical axis L, thereby enabling autofocus or a hand-induced-shake correction function.

The sensor cover 330 incorporates the image pickup element 220. The sensor cover 330 has an upper surface (positive Z-axis direction) on which an opening 330a is provided so as not to avoid the image pickup element 220 from taking images of the chart patterns 211. The lower end of the sensor cover 330 and the upper surface of the substrate 340 are fixed together with an adhesive. The fixed lens 112 of the imaging lens 110 is desirably held in such a manner that its position in the direction of the optical axis L is accurate with respect to the image pickup element 220.

The substrate 340 incorporates a circuit that communicates input and output signals of the image pickup element 220 to the control unit 180A. The lower surface of the image pickup element 220 (a surface opposite to a surface adjacent to the imaging lens 110) is fixed to the upper surface of the substrate 340 (a surface adjacent to the imaging lens 110) with an adhesive.

Further, the semifinished camera module 310 may incorporate an infrared-rays cutting filter, not shown. The infrared-rays cutting filter is joined to the sensor cover 330 so as to cover the opening 330a and has the function of not only avoiding light beams with unnecessary wavelengths from intruding into the image pickup element 220, but also avoiding foreign substances from attaching to the image pickup element 220.

It is noted that in a method for manufacturing a camera module, the camera-module manufacturing apparatus 300 adjusts the imaging lens 110 in a manner similar to that in the imaging-lens manufacturing apparatus 200.

### Effects

A method of adjusting a tilt in the imaging lens 110 or in an image sensor in conformance with a tilt of the optical axis L of the imaging lens 110 is typically called active alignment (hereinafter, AA), which is known as a method for manufacturing a camera module. However, performing AA requires a dedicated apparatus, which is unfortunately expensive, and unfortunately complicates the manufacturing process.

Further, AA, which can utilize the performance of the imaging lens 110 at maximum, is an effective method for manufacturing a camera module, but cannot absorb a tilt of the optical axis L of the imaging lens 110 without limitation. Using the imaging lens 110 with the optical axis L greatly tilted possibly leads to a reduction in the ratio of non-defective products in the process of manufacturing a camera module.

Hence, a tilt of the optical axis L should be avoided as much as possible in a means for adjusting the imaging lens 110, and thus, the foregoing adjustment means in Japanese Unexamined Patent Application Publication No. 2010-230745 is unfavorable in view of camera module manufacture.

In contrast to this, the imaging-lens manufacturing apparatus 100, 200 and camera-module manufacturing apparatus 300 according to the foregoing preferred embodiments are directed not to tilting the optical axis L in the adjustment of the imaging lens 110, but to moving and rotating the adjusted lens 111 in the plane perpendicular to the optical axis L to adjust the imaging lens 110. As a result, a high-accuracy imaging lens 110 or high-accuracy camera module with a reduced tilt in each of the tangential image plane and sagittal image plane, that is, with a reduced tilt of the optical axis L of the imaging lens 110, can be manufactured. This can prevent a reduction in the ratio of non-defective products in the process of manufacturing a camera module.

### Implementation by Software

The functions of the control unit 180, 180A of the imaging-lens manufacturing apparatuses 100, 200 and of the camera-module manufacturing apparatus 300 can be implemented by a program for a computer to function as the control unit 180, 180A.

The apparatus in this case includes a computer having, as hardware for executing the program, at least one controller (e.g., a processor) and at least one storage (e.g., a memory). Executing the program with these controller and memory implements the individual functions described in the foregoing preferred embodiments.

The program may be stored in one or more non-transitory computer-readable storage media. These storage media may or may not be included in the foregoing apparatus. In the latter case, the program may be supplied to the apparatus via any wired or wireless transmission medium.

Further, the functions of the foregoing individual control blocks can be achieved in part or in whole by logic circuits. For instance, an integrated circuit in which logic circuits that function as the respective control blocks are formed is also included in the scope of the present invention. Other than the foregoing, the functions of the individual control blocks can be implemented by, for instance, a quantum computer.

Further, the individual processes described in the foregoing respective preferred embodiments may be executed by artificial intelligence (AI). AI in this case may be operated by the foregoing controller or other devices (e.g., an edge computer or a Cloud server).

### Summary

An imaging-lens manufacturing apparatus (100) according to a first aspect of the present invention manufactures an imaging lens (110) provided with a plurality of lenses including an adjusted lens (111) that is used in assembly. The imaging-lens manufacturing apparatus (100) includes the following: a stage (140) configured to hold at least the plurality of lenses (fixed lens 112) excluding the adjusted lens; a lens adjusting mechanism (130) configured to hold the adjusted lens, and capable of adjusting, in a plane perpendicular to the optical axis (L) of the imaging lens, the position of the adjusted lens with respect to the plurality of lenses excluding the adjusted lens; a light source (160); a reticle (150) disposed between the imaging lens and the light source, and having three or more slits (151) that allow light from the light source to pass; and a light detecting unit (120) having a plurality of sensors (121) each configured to detect, via the imaging lens, a corresponding one of a plurality of light-ray bundles composed of the light from the light source passed through the three or more slits, wherein the lens adjusting mechanism is further capable of adjusting a tilt angle of the adjusted lens with respect to the optical axis, and the tilt angle undergoes adjustment by rotating the adjusted lens about a rotation center point (RC) located on the optical axis.

The foregoing configuration enables the imaging-lens manufacturing apparatus to adjust the tilt angle of the adjusted lens with respect to the optical axis, and thus, the imaging-lens manufacturing apparatus can prevent a tilt of a tangential image plane and a tilt of a sagittal image plane and can adjust the adjusted lens without tilting the optical axis L. This enables the imaging-lens manufacturing apparatus to manufacture a higher-accuracy imaging lens with a reduced tilt of each of the tangential image plane and sagittal image plane.

The imaging-lens manufacturing apparatus (100) according to a second aspect of the present invention may further include, in the first aspect, a control unit, wherein the control unit is configured to derive the optical performance of the imaging lens (110) from an image formed by the light-ray bundle detected by the sensor (121), calculate a tilt of a tangential image plane and a tilt of a sagittal image plane in accordance with the optical performance derived, and control the lens adjusting mechanism (130) in accordance with the tilt of the tangential image plane calculated and the tilt of the sagittal image plane calculated.

The foregoing configuration enables the imaging-lens manufacturing apparatus to adjust the imaging lens on the basis of the lens' optical performance as a product, and thus, the imaging-lens manufacturing apparatus can manufacture a high-accuracy imaging lens.

An imaging-lens manufacturing apparatus (200) according to a third aspect of the present invention manufactures an imaging lens (110) provided with a plurality of lenses including an adjusted lens (111) that is used in assembly. The imaging-lens manufacturing apparatus (200) includes the following: a stage (140) configured to hold at least the plurality of lenses (fixed lens 112) excluding the adjusted lens; a lens adjusting mechanism (130) configured to hold the adjusted lens, and capable of adjusting, in a plane perpendicular to the optical axis (L) of the imaging lens, the position of the adjusted lens with respect to the plurality of lenses excluding the adjusted lens; a chart (210) with a pattern (211) formed so that the optical performance in the tangential direction and sagittal direction of the imaging lens is evaluable; and an image pickup element (220) configured to take an image of the chart through the imaging lens, wherein the lens adjusting mechanism is further capable of adjusting a tilt angle of the adjusted lens with respect to the optical axis, and the tilt angle undergoes adjustment by rotating the adjusted lens about a rotation center point (RC) located on the optical axis.

The foregoing configuration enables the imaging-lens manufacturing apparatus to adjust the tilt angle of the adjusted lens with respect to the optical axis, and thus, the imaging-lens manufacturing apparatus can prevent a tilt of a tangential image plane and a tilt of a sagittal image plane and can adjust the adjusted lens without tilting the optical axis L.

Further, the imaging-lens manufacturing apparatus, which adjusts the adjusted lens on the basis of an output from the image pickup element, can adjust the adjusted lens under a condition closer to a product. This enables the imaging-lens manufacturing apparatus to manufacture a higher-accuracy imaging lens with a reduced tilt of each of the tangential image plane and sagittal image plane.

The imaging-lens manufacturing apparatus (200) according to a fourth aspect of the present invention may further include, in the third aspect, a control unit, wherein the control unit is configured to derive the optical performance of the imaging lens (110) from a signal output from the image pickup element (220), calculate a tilt of a tangential image plane and a tilt of a sagittal image plane in accordance with the optical performance derived, and control the lens adjusting mechanism (130) in accordance with the tilt of the tangential image plane calculated and the tilt of the sagittal image plane calculated.

The foregoing configuration enables the imaging-lens manufacturing apparatus to adjust the imaging lens on the basis of the lens' optical performance as a product, and thus, the imaging-lens manufacturing apparatus can manufacture a high-accuracy imaging lens.

The imaging-lens manufacturing apparatus (100, 200) according to a fifth aspect may be configured, in the first to fourth aspects, such that a positional-adjustment amount (x) of the adjusted lens that undergoes positional adjustment in the plane perpendicular to the optical axis (L), and a rotational-adjustment amount (t) of the adjusted lens that undergoes adjustment to the tilt angle satisfy the following Expression (E1), Expression (E2) and Expression (E3), where PSi1 denotes a difference in focal length in a tangential image plane, where PSi2 denotes a difference in focal length in a sagittal image plane, where k1 denotes a degree of sensitivity at which the difference in focal length varies per unit of movement amount in the plane perpendicular to the optical axis in the tangential image plane, where k2 denotes a degree of sensitivity at which the difference in focal length varies per unit of movement amount in the plane perpendicular to the optical axis in the sagittal image plane, where k3 denotes a degree of sensitivity at which the difference in focal length varies per unit of rotation amount in the tangential image plane, where k4 denotes a degree of sensitivity at which the difference in focal length varies per unit of rotation amount in the sagittal image plane, where xt denotes an amount of movement in the plane perpendicular to the optical axis in response to a rotation of the adjusted lens:

PSi1−(k1x+k3t)=0 Expression (E1),

PSi2−(k2x+k4t)=0 Expression (E2), and

|x/xt|≥1 Expression (E3).

Expressions (1) and Expression (2) in the foregoing configuration define the positional-adjustment amount in the perpendicular plane of the adjusted lens, and the rotational-adjustment amount of the adjusted lens. Satisfying Expression (1) and Expression (2) can prevent a tilt of each of the tangential image plane and sagittal image plane and can adjust the adjusted lens. Further, the positional-adjustment amount in the perpendicular plane of the adjusted lens, and the rotational-adjustment amount of the adjusted lens can be determined instantaneously based on Expression (1) and Expression (2) through a simple calculation, with an optical-axis tilt of the entire imaging lens prevented.

The imaging-lens manufacturing apparatus (100, 200) according to a sixth aspect of the present invention may be configured, in the fifth aspect, such that the degree of sensitivity (k3) at which the difference in focal length varies per unit of rotation amount in the tangential image plane, and the degree of sensitivity (k4) at which the difference in focal length varies per unit of rotation amount in the sagittal image plane are calculated by rotating the adjusted lens (111) about the rotation center point (RC) by a predetermined angle (tc).

The foregoing configuration enables an optimal positional-adjustment amount in the perpendicular plane of the adjusted lens and an optimal rotational-adjustment amount of the adjusted lens to be calculated without being affected by the imaging-lens manufacturing apparatus and the condition where the imaging lens is held.

The imaging-lens manufacturing apparatus (100, 200) according to a seventh aspect, may be configured, in the sixth aspect, such that a distance (r) in the direction of the optical axis from the principle point of the adjusted lens to the rotation center point is expressed by the following Expression (4), where tc denotes the predetermined angle for rotating the adjusted lens about the rotation center point, where k3 denotes a degree of sensitivity at which the difference in focal length varies per unit of rotation amount in the tangential image plane, where k1 denotes a degree of sensitivity at which the difference in focal length varies per unit of movement amount in the plane perpendicular to the optical axis in the tangential image plane, where k3c denotes a degree of sensitivity at which the difference in focal length varies per unit of rotation amount in the tangential image plane when r=0 is satisfied:

r=(k3tc−k3ctc)/(k1 sin tc) Expression (E4).

The foregoing configuration, which enables the distance in the direction of the optical axis from the principle point of the adjusted lens to the rotation center point to be calculated instantaneously through Expression (E4) and enables positional variation in the rotation center point to be monitored, is effective in the maintenance of the imaging-lens manufacturing apparatus.

A camera-module manufacturing apparatus (300) according to an eighth aspect of the present invention manufactures a camera module (310) having an imaging lens and an image pickup element. The imaging lens is provided with a plurality of lenses including an adjusted lens (111) that is used in assembly. The camera-module manufacturing apparatus (300) includes the following: a stage (140) configured to hold the camera module; a lens adjusting mechanism (130) configured to hold the adjusted lens, and capable of adjusting, in a plane perpendicular to the optical axis (L) of the imaging lens, the position of the adjusted lens with respect to the plurality of lenses (fixed lens 112) excluding the adjusted lens; and a chart (210) with a pattern (211) formed so that the optical performance in the tangential direction and sagittal direction of the imaging lens is evaluable, wherein the lens adjusting mechanism is further capable of adjusting a tilt angle of the adjusted lens with respect to the optical axis, and the tilt angle undergoes adjustment by rotating the adjusted lens about a rotation center point (RC) located on the optical axis of the imaging lens.

The foregoing configuration enables the camera-module manufacturing apparatus to adjust the tilt angle of the adjusted lens with respect to the optical axis, and thus, the camera-module manufacturing apparatus can adjust the adjusted lens without tilting the optical axis L while preventing a tilt of each of the tangential image plane and sagittal image plane.

Further, the camera-module manufacturing apparatus, which adjusts the adjusted lens on the basis of an output from the image pickup element, can adjust the adjusted lens under a condition closer to a product. The camera-module manufacturing apparatus can furthermore make an adjustment into the best optical performance in a finished camera module. This enables the camera-module manufacturing apparatus to manufacture a higher-accuracy imaging lens with a reduced tilt of each of the tangential image plane and sagittal image plane.

The camera-module manufacturing apparatus (300) according to a ninth aspect of the present invention may further include, in the eighth aspect, a control unit, wherein the control unit is configured to derive the optical performance of the imaging lens (110) from a signal output from the image pickup element (220), calculate a tilt of a tangential image plane and a tilt of a sagittal image plane in accordance with the optical performance derived, and control the lens adjusting mechanism (130) in accordance with the tilt of the tangential image plane calculated and the tilt of the sagittal image plane calculated.

The foregoing configuration enables the camera-module manufacturing apparatus to adjust the imaging lens on the basis of the lens' optical performance as a product, and thus, the camera-module manufacturing apparatus can manufacture a camera module having a high-accuracy imaging lens.

The imaging-lens manufacturing apparatus 100, 200 and camera-module manufacturing apparatus 300 according to the respective aspects of the present invention may be implemented by a computer. In this case, a control program for the imaging-lens manufacturing apparatus 100, 200 and camera-module manufacturing apparatus 300 with which a computer implements the imaging-lens manufacturing apparatus 100, 200 and camera-module manufacturing apparatus 300 by operating as each unit (software element) included in the imaging-lens manufacturing apparatus 100, 200 and camera-module manufacturing apparatus 300, and a computer-readable storage medium storing this control program are also included in the scope of the present invention.

The present invention is not limited to the foregoing preferred embodiments. Various modifications can be devised within the scope of the claims. A preferred embodiment that is obtained in combination, as appropriate, with the technical means disclosed in the respective preferred embodiments is also included in the technical scope of the present invention. Furthermore, combining the technical means disclosed in the respective preferred embodiments can form a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An imaging-lens manufacturing apparatus that manufactures an imaging lens provided with a plurality of lenses including an adjusted lens that is used in assembly, the imaging-lens manufacturing apparatus comprising:
a stage configured to hold at least the plurality of lenses excluding the adjusted lens;
a lens adjusting mechanism configured to hold the adjusted lens, and capable of adjusting, in a plane perpendicular to an optical axis of the imaging lens, a position of the adjusted lens with respect to the plurality of lenses excluding the adjusted lens;
a light source;
a reticle disposed between the imaging lens and the light source, and having three or more slits that allow light from the light source to pass; and
a light detecting unit having a plurality of sensors each configured to detect, via the imaging lens, a corresponding one of a plurality of light-ray bundles composed of the light from the light source passed through the three or more slits,
wherein the lens adjusting mechanism is further capable of adjusting a tilt angle of the adjusted lens with respect to the optical axis, and the tilt angle undergoes adjustment by rotating the adjusted lens about a rotation center point located on the optical axis.

2. The imaging-lens manufacturing apparatus according to claim 1, further comprising a control unit,
wherein the control unit is configured to
derive optical performance of the imaging lens from an image formed by the light-ray bundle detected by the sensor, and calculate a tilt of a tangential image plane and a tilt of a sagittal image plane in accordance with the optical performance derived, and
control the lens adjusting mechanism in accordance with the tilt of the tangential image plane calculated and the tilt of the sagittal image plane calculated.

3. The imaging-lens manufacturing apparatus according to claim 1, wherein a positional-adjustment amount (x) of the adjusted lens that undergoes positional adjustment in the plane perpendicular to the optical axis, and a rotational-adjustment amount (t) of the adjusted lens that undergoes adjustment to the tilt angle satisfy the following Expression (E1), Expression (E2) and Expression (E3), where PSi1 denotes a difference in focal length in a tangential image plane, where PSi2 denotes a difference in focal length in a sagittal image plane, where k1 denotes a degree of sensitivity at which the difference in focal length varies per unit of movement amount in the plane perpendicular to the optical axis in the tangential image plane, where k2 denotes a degree of sensitivity at which the difference in focal length varies per unit of movement amount in the plane perpendicular to the optical axis in the sagittal image plane, where k3 denotes a degree of sensitivity at which the difference in focal length varies per unit of rotation amount in the tangential image plane, where k4 denotes a degree of sensitivity at which the difference in focal length varies per unit of rotation amount in the sagittal image plane, where xt denotes an amount of movement in the plane perpendicular to the optical axis in response to a rotation of the adjusted lens:
PSi1−(k1x+k3t)=0 Expression (E1),
PSi2−(k2x+k4t)=0 Expression (E2), and

|x/xt|≥1 Expression (E3).

4. The imaging-lens manufacturing apparatus according to claim 3, wherein the degree of sensitivity at which the difference in focal length varies per unit of rotation amount in the tangential image plane, and the degree of sensitivity at which the difference in focal length varies per unit of rotation amount in the sagittal image plane are calculated by rotating the adjusted lens about the rotation center point by a predetermined angle.

5. The imaging-lens manufacturing apparatus according to claim 4, wherein a distance (r) in the direction of the optical axis from a principle point of the adjusted lens to the rotation center point is expressed by the following Expression (4), where tc denotes the predetermined angle for rotating the adjusted lens about the rotation center point, where k3 denotes a degree of sensitivity at which the difference in focal length varies per unit of rotation amount in the tangential image plane, where k1 denotes a degree of sensitivity at which the difference in focal length varies per unit of movement amount in the plane perpendicular to the optical axis in the tangential image plane, where k3c denotes a degree of sensitivity at which the difference in focal length varies per unit of rotation amount in the tangential image plane when r=0 is satisfied:
r=(k3tc−k3ctc)/(k1 sin tc) Expression (E4).

6. An imaging-lens manufacturing apparatus that manufactures an imaging lens provided with a plurality of lenses including an adjusted lens that is used in assembly, the imaging-lens manufacturing apparatus comprising:
a stage configured to hold at least the plurality of lenses excluding the adjusted lens;
a lens adjusting mechanism configured to hold the adjusted lens, and capable of adjusting, in a plane perpendicular to an optical axis of the imaging lens, a position of the adjusted lens with respect to the plurality of lenses excluding the adjusted lens;
a chart with a pattern formed so that optical performance in a tangential direction and a sagittal direction of the imaging lens is evaluable; and
an image pickup element configured to take an image of the chart through the imaging lens,
wherein the lens adjusting mechanism is further capable of adjusting a tilt angle of the adjusted lens with respect to the optical axis, and the tilt angle undergoes adjustment by rotating the adjusted lens about a rotation center point located on the optical axis.

7. The imaging-lens manufacturing apparatus according to claim 6, further comprising a control unit,
wherein the control unit is configured to
derive the optical performance of the imaging lens from a signal output from the image pickup element, and calculate a tilt of a tangential image plane and a tilt of a sagittal image plane in accordance with the optical performance derived, and
control the lens adjusting mechanism in accordance with the tilt of the tangential image plane calculated and the tilt of the sagittal image plane calculated.

8. The imaging-lens manufacturing apparatus according to claim 6, wherein a positional-adjustment amount (x) of the adjusted lens that undergoes positional adjustment in the plane perpendicular to the optical axis, and a rotational-adjustment amount (t) of the adjusted lens that undergoes adjustment to the tilt angle satisfy the following Expression (E1), Expression (E2) and Expression (E3), where PSi1 denotes a difference in focal length in a tangential image plane, where PSi2 denotes a difference in focal length in a sagittal image plane, where k1 denotes a degree of sensitivity at which the difference in focal length varies per unit of movement amount in the plane perpendicular to the optical axis in the tangential image plane, where k2 denotes a degree of sensitivity at which the difference in focal length varies per unit of movement amount in the plane perpendicular to the optical axis in the sagittal image plane, where k3 denotes a degree of sensitivity at which the difference in focal length varies per unit of rotation amount in the tangential image plane, where k4 denotes a degree of sensitivity at which the difference in focal length varies per unit of rotation amount in the sagittal image plane, where xt denotes an amount of movement in the plane perpendicular to the optical axis in response to a rotation of the adjusted lens:
PSi1−(k1x+k3t)=0 Expression (E1),
PSi2−(k2x+k4t)=0 Expression (E2), and

|x/xt|≥1 Expression (E3).

9. The imaging-lens manufacturing apparatus according to claim 8, wherein the degree of sensitivity at which the difference in focal length varies per unit of rotation amount in the tangential image plane, and the degree of sensitivity at which the difference in focal length varies per unit of rotation amount in the sagittal image plane are calculated by rotating the adjusted lens about the rotation center point by a predetermined angle.

10. The imaging-lens manufacturing apparatus according to claim 9, wherein a distance (r) in the direction of the optical axis from a principle point of the adjusted lens to the rotation center point is expressed by the following Expression (4), where tc denotes the predetermined angle for rotating the adjusted lens about the rotation center point, where k3 denotes a degree of sensitivity at which the difference in focal length varies per unit of rotation amount in the tangential image plane, where k1 denotes a degree of sensitivity at which the difference in focal length varies per unit of movement amount in the plane perpendicular to the optical axis in the tangential image plane, where k3c denotes a degree of sensitivity at which the difference in focal length varies per unit of rotation amount in the tangential image plane when r=0 is satisfied:
r=(k3tc−k3ctc)/(k1 sin tc) Expression (E4).

11. A camera-module manufacturing apparatus that manufactures a camera module having an imaging lens and an image pickup element, the imaging lens being provided with a plurality of lenses including an adjusted lens that is used in assembly, the camera-module manufacturing apparatus comprising:
a stage configured to hold the camera module;
a lens adjusting mechanism configured to hold the adjusted lens, and capable of adjusting, in a plane perpendicular to an optical axis of the imaging lens, a position of the adjusted lens with respect to the plurality of lenses excluding the adjusted lens; and
a chart with a pattern formed so that optical performance in a tangential direction and a sagittal direction of the imaging lens is evaluable,
wherein the lens adjusting mechanism is further capable of adjusting a tilt angle of the adjusted lens with respect to the optical axis, and the tilt angle undergoes adjustment by rotating the adjusted lens about a rotation center point located on the optical axis of the imaging lens.

12. The camera-module manufacturing apparatus according to claim 11, further comprising a control unit,
wherein the control unit is configured to
derive the optical performance of the imaging lens from a signal output from the image pickup element, and calculate a tilt of a tangential image plane and a tilt of a sagittal image plane in accordance with the optical performance derived, and
control the lens adjusting mechanism in accordance with the tilt of the tangential image plane calculated and the tilt of the sagittal image plane calculated.
